(19) United States
(12) Patent Application Publication
(10) Pub. No.: US 2026/0184357 A1
(43) Pub. Date: Jul. 2, 2026

(54) SYSTEMS AND METHODS WITH ENHANCED PREDICTIVE RAILROAD CROSSING TRAFFIC NOTIFICATION AND RAILROAD WORKER SAFETY NOTIFICATION

(71) Applicant: THE ISLAND RADAR COMPANY, Olathe, KS (US)

(72) Inventor: Thomas N. Hilleary, Lenexa, KS (US)

(21) Appl. No.: 19/346,131

(22) Filed: Sep. 30, 2025

Related U.S. Application Data
(63) Continuation-in-part of application No. 18/054,572, filed on Nov. 11, 2022.

(51) Int. Cl. B61L 29/32; B61L 25/02; B61L 27/40; B61L 29/30; G06F 3/16; G08B 7/06; G08B 21/02; G08B 25/01

(52) U.S. Cl. CPC B61L 29/32; B61L 25/02; B61L 27/40; B61L 29/30; G06F 3/167; G08B 7/06; G08B 21/02; G08B 25/016; B61L 2205/04

(57) ABSTRACT

A system that predictively estimates a time of arrival of a locomotive at public or private railroad crossings. Remote processor-based devices receive the predictively estimated time of arrival of the locomotive for the identified public or private railroad crossings to improve safety on the roadway at each of the plurality of railroad crossings. The system also provides a predictively estimated time of arrival of a locomotive at a railroad worker location that does not coincide with a public or private railroad crossing.

### CROSS REFERENCE TO RELATED APPLICATIONS

This application is a continuation-in-part application of U.S. patent application Ser. No. 18/054,572 filed Nov. 11, 2022, which is hereby incorporated by reference in its entirety.

### BACKGROUND OF THE INVENTION

The field of the invention relates generally to intelligent traffic control safety systems and methods, and more specifically to intelligent processor-based systems and methods that enhance safety at railroad crossings and enable enhanced vehicle navigation routing and dispatch by predictively determining, without requiring physical train-detection systems at each of a plurality of railroad crossings, an estimated time of train arrival at the plurality of different railroad crossings and a respective duration of blocked railroad crossings by the respective trains at each crossing.

Railroad crossing detection and notification systems are known that physically sense and detect an actual presence of a locomotive train as it approaches an intersection of a railroad track (or tracks) and a road surface for automotive vehicle use, referred to herein as a rail grade crossing. While such known railroad crossing detection and notification systems do improve safety of locomotive train passage, roadway vehicle passage, and any workers or pedestrians in and around crossings where they are installed, they tend to be cost-prohibitive for many crossing locations. As a result, many railroad crossings today lack any ability to sense train presence or to notify motorists or persons at the crossing sites of oncoming trains.

Existing railroad crossing detection and notification systems that operate in response to physical train detection at the crossing also undesirably cause substantial vehicular traffic disruption and inefficiency due to crossing detection and notification systems operating shortly before the actual train arrival at the crossing. Operation of such systems shortly before the train arrives is a design feature of conventional railroad crossing detection and notification systems, but it consequentially means that there is very little lead time for vehicle traffic systems and drivers to avoid seemingly unpredictable train movements resulting in blocked railroad crossings.

Affordable and effective railroad crossing safety notification systems with longer lead times to facilitate improved crossing safety and improved vehicle traffic system efficiencies and enhancements are therefore desired.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is a block diagram of an intelligent processor-based predictive railroad crossing safety notification and traffic control system according to a first exemplary embodiment of the present invention.

FIG. 2 is a block diagram of an intelligent processor-based predictive railroad crossing safety notification and traffic control system according to a second exemplary embodiment of the present invention.

FIG. 3 is a block diagram of the predictive railroad crossing notification system shown in FIGS. 1 and 2.

FIG. 4 schematically illustrates an operation of the predictive railroad crossing notification and traffic control systems shown in FIGS. 1-3.

FIG. 5 is block diagram of the system shown in FIG. 4.

FIG. 6 is a block diagram of a first exemplary subsystem of the exemplary predictive railroad crossing notification and traffic control system shown in FIGS. 4 and 5.

FIG. 7 is a block diagram of an exemplary railroad crossing notification system for the system shown in FIGS. 4-6.

FIG. 8 is a block diagram of a second exemplary subsystem of the exemplary predictive railroad crossing notification and traffic control system shown in FIGS. 4 and 5.

FIG. 9 is a block diagram of a first exemplary embodiment of a vehicle navigation system for the system shown in FIGS. 4, 5 and 8.

FIG. 10 is a block diagram of a second exemplary embodiment of a vehicle navigation system for the system shown in FIGS. 4, 5 and 8.

FIG. 11 is a block diagram of a third exemplary subsystem of the exemplary predictive railroad crossing notification and traffic control system shown in FIGS. 4 and 5.

FIG. 12 is a block diagram of a first exemplary embodiment of a driver notification system for the system shown in FIGS. 4, 5 and 11.

FIG. 13 is a block diagram of a fourth exemplary subsystem of the exemplary predictive railroad crossing notification and traffic control system shown in FIGS. 4 and 5.

FIG. 14 is a block diagram of an exemplary embodiment of a vehicle dispatch system for the system shown in FIGS. 4, 5 and 13.

FIG. 15 is a block diagram of a fifth exemplary subsystem of the exemplary predictive railroad crossing notification and traffic control system shown in FIGS. 4 and 5.

FIG. 16 is a block diagram of an exemplary embodiment of a vehicle route signage system for the system shown in FIGS. 4, 5 and 15.

FIG. 17 illustrates an exemplary embodiment of electronic signage for the vehicle route signage system displaying a first crossing message.

FIG. 18 illustrates an exemplary embodiment of electronic signage for the vehicle route signage system displaying a second crossing message.

FIG. 19 illustrates an exemplary embodiment of electronic signage for the vehicle route signage system displaying a third crossing message.

FIG. 20 illustrates an exemplary embodiment of electronic signage for the vehicle route signage system displaying a fourth crossing message.

FIG. 21 illustrates an exemplary embodiment of electronic signage for the vehicle route signage system displaying a fifth crossing message.

FIG. 22 illustrates an exemplary embodiment of electronic signage for the vehicle route signage system displaying a sixth crossing message.

FIG. 23 schematically illustrates an operation of the predictive railroad crossing notification system.

FIG. 24 is an algorithmic flowchart of exemplary processes performed by the intelligent, processor-based predictive railroad crossing notification and traffic control system of the present invention.

FIG. 25 is a block diagram of an intelligent processor-based predictive railroad crossing safety notification and traffic control system according to a third exemplary embodiment of the present invention.

FIGS. 26A and 26B schematically illustrate respective portions of an operation of the predictive railroad crossing notification and traffic control system shown in FIG. 25.

FIG. 27 is block diagram of the system shown in FIG. 26.

FIG. 28 is a block diagram of an exemplary subsystem of the exemplary predictive railroad crossing notification and traffic control system shown in FIGS. 25-27.

FIG. 29 is a block diagram of an exemplary embodiment of a hands free virtual assistant device for the system shown in FIGS. 25-28.

FIG. 30 is an exemplary algorithmic flow chart of hands free virtual assistant device in providing predictive estimate information for a crossing.

FIG. 31 is a first elevational view of first exemplary embodiment of a railroad crossing signage for a railroad crossing which is responsive to the predictive railroad crossing notification and traffic control system shown in FIGS. 25-27.

FIG. 32 is a first elevational view of second exemplary embodiment of a railroad crossing signage for a railroad crossing which is responsive to the predictive railroad crossing notification and traffic control system shown in FIGS. 25-27.

FIG. 33 is a first elevational view of second exemplary embodiment of a railroad crossing signage for a railroad crossing which is responsive to the predictive railroad crossing notification and traffic control system shown in FIGS. 25-27.

FIG. 34 is a block diagram of another exemplary subsystem of the exemplary predictive railroad crossing notification and traffic control system shown in FIGS. 25-27.

FIG. 35 is a block diagram of an exemplary embodiment of a railroad worker safety device for the system shown in FIGS. 25-27 and 34.

FIG. 36 is an exemplary algorithmic flow chart of an operation of the railroad worker safety device in providing predictive estimate information for an operating train.

FIG. 37 schematically illustrates a railroad car reader subsystem in communication with the predictive railroad crossing notification system 300.

FIG. 38 schematically illustrates a railroad car interface with a portion of the subsystem shown in FIG. 37.

FIG. 39 schematically illustrates an operation of the interface and subsystem of FIGS. 38 and 37 collecting data from railroad cars in a moving train.

### DETAILED DESCRIPTION OF THE INVENTION

In order to understand the systems and methods of the invention to the greatest extent, set forth below is a discussion of the state of the art of railroad crossing detection and notification systems and substantial longstanding but unresolved problems in the art, followed by a disclosure of exemplary inventive processor-based systems and methods beneficially overcoming the limitations of conventional railroad crossing detection and notification systems and methods.

### I. State of the Art

Railroad crossing detection and notification systems are well known and have long been used to detect a locomotive train via physical sensor system as a train approaches certain intersections of a railroad track (or tracks) and roadway surface for automotive vehicle use, referred to herein as a rail grade crossing. Different variations of known crossing detection and notification systems are in current use across the United States at public and private crossings.

The United States currently has more than 130,000 public at-grade railroad crossings. About half of these public crossings have active crossing warning systems including flashing lights and/or barrier gates to warn motorists of arriving trains and to prevent roadway vehicles from entering into the crossing in the path of a train. More specifically, about 35% of public crossings have flashing lights and gates, and about 16% have flashing lights with no gates. While such active warning systems significantly improve safety at the crossings where they are installed, they are not infallible. More than 60% of train-automobile collisions occur at public crossings with active warning systems, a portion of which are attributable to driver error or disobedience. Drivers have been known to race the train to the crossing. ignore safety notifications, or drive around barrier gates when there is seemingly no train in sight. Higher speed trains, however, may descend on the crossing much more quickly than drivers anticipate.

Public crossings with passive warning systems also exist, which include the use of crossbucks (the familiar x-shaped signs that mean yield to the train), yield or stop signs, and pavement markings. Passive warning systems depend primarily on the vigilance of motorists proceeding through the crossings, but on occasion drivers again can be tempted to beat the train to the crossing to avoid delay of the crossing being blocked, or fail to see or appreciate how soon the train will be at the crossing.

In addition to public crossings, there are almost 80,500 private railroad crossings, most of which do not have active crossing warning systems, and which account for approximately 40% of train-automobile collisions. Again, a portion of the collisions at the crossings are due to driver error in trying to clear the crossing before the train arrives in order to avoid delay of the train passing through the crossing.

In many cases, railroad crossing detection and notification systems are owned and controlled by a railroad operator. Known railroad-owned and controlled crossing detection and notification systems are designed, however, predominately from a safety perspective at each crossing where they are installed. Railroad-owned and controlled crossing detection systems are typically employed selectively in certain high traffic volume urban corridors presenting significant safety concerns from the railroad's perspective, but for crossings in many lower volume traffic areas such as smaller municipalities and rural areas, railroad-owned and controlled detection and notification systems are cost-prohibitive and are not utilized. Potential funding for such railroad-operated and controlled detection and notification systems by towns cities and municipalities for hardware and equipment maintenance is often prohibitively high.

Existing railroad crossing active warning systems benefit the railroad organization and also vehicle drivers in safety aspects aimed to avoid train-vehicle collisions. From the perspective of vehicle traffic flow, however, active warning systems present substantial disruption and delay, and sometimes unnecessary disruption and delay to vehicular traffic in the vicinity of the railroad crossing where such active warning systems are operating. The active warning systems may operate in a seemingly unpredictable manner to many drivers, vehicle navigation and routing systems, or to vehicle dispatch systems. In addition, known active warning systems tend to operate with very little lead time for drivers, vehicle navigation systems and routing systems, or vehicle dispatch systems to consider and evaluate alternative routes that may optimally avoid a blocked crossing by an arriving train. The same is generally true for passive warning systems in that drivers and vehicle routing systems may be effectively surprised by an arriving train with very little lead time to react before traffic is stopped.

Collectively, trains moving through railroad crossings block vehicular traffic at a rate of more than 1,800,000 times per day. According to the FRA (Federal Railroad Administration) and the FHWA (Federal Highway Administration) these blocked crossing events idle traffic for between 66 million and 175 million hours per year. Since train length and speed can vary dramatically, from the driver perspective the amount of time (and corresponding delay) for any given train to clear the crossing is generally unpredictable, and in the event that a train temporarily stops moving drivers at the crossing face vast uncertainty when the crossing will be cleared for passage. As an indicator of the scope of this issue, and the annoyance imposed upon the motoring public, in 2018, more than 50,000 cellphone calls were placed to BNSF Railroad alone inquiring about how long a crossing was going to remain blocked because of a moving or stationary freight train.

As a further indicator of the scope of the problems that are presented by blocked crossings, the Federal Railroad Administration (FRA) has a webpage for the public and law enforcement to report blocked crossings by date, time, location, and duration. See https://www.fra.dot.gov/blockedcrossings/. Data highlights provided through November 2021 for blocked crossing events reported through the webpage are by Office at reported the of Railroad Safety https://railroads.dot.gov/elibrary/blocked-crossings-fast-facts. In the November 2021 report, the Office of Railroad Safety states that data collected from the webpage “helps FRA to identify where chronic problems exist and to better assess the underlying causes and overall impacts of blocked crossings.” FRA further seeks to facilitate “local solutions with railroads and local authorities”, yet such solutions have yet to be realized.

Apart from travel disruption and delay associated with blocked crossings, idled traffic in the range of 65 million to 175 million hours is undesirable from other perspectives, including but not limited to unproductive fossil fuel consumption and undesirable vehicle emissions of idled traffic that may present public policy concerns from environmental, climate and energy policies to local, state and federal authorities. The public at large may therefore benefit from an effective solution to idled traffic due to trains moving through railroad crossings.

Third party (i.e., non-railroad entity) train detection and notification systems have been developed that operate independently from railroad-operated train detection and notification systems, and such third party systems may be utilized in tandem with railroad-operated train detection systems at certain crossings to add additional functionality or at railroad crossings where no railroad-operated train detection system exists. For example, radar-based sensing systems are available from Island Radar LLC of Springville, Utah (https://www.islandradar.com/) that may be installed above-ground and operated reliably with much lower cost than most railroad-operated train detection systems including long track circuits integrated in the railroad tracks and buried inductive loops in the railroad right-of-way, for example. As such, third party train detection and notifications systems may be advantageously retrofit to crossings where the railroad itself has not provided any of its own equipment to detect a train or warn motorists of an arriving train.

In some cases train speed detection is possible at the crossing where train detection systems are installed, but in a site specific manner that precludes sensed train speed changes before or after that train reaches the specific site. As such, very limited predictive ability exists within a short time window before the train actually reaches the roadway for the crossing concerned, and sufficient lead time for proactive decision making to avoid crossings with imminent train arrival is not possible. Additionally, existing train detection systems tend to rely on stand-alone wireless communications systems to harvest train movement information, which can sometimes be unreliable and therefore unsuitable for reliable predicting train arrival for the benefit of roadway vehicles.

U.S. Pat. Nos. 10,665,118 and 10,967,894 of Island Radar, the disclosures of which are hereby incorporated by reference in their entirety, teach physical detection of trains utilizing third party supplied radar and infrared detectors, and communication of impending roadway blockages to a crossing ahead of those detection points to signage located at the crossings for the benefit of motorists. The crossings outfitted with radar and infrared detectors or sensors may or may not include active warning systems of the railroad operator. While costs of installation of such a third party train detection is lower than the cost of installing a typical railroad-operated train detection system including track circuits and the like to detect train presence, the cost can still be significant at it requires the installation of equipment at specific points along the railroad right-of-way, along with power, wireless communication links, and dynamic signage. Simpler and lower cost third party solutions are desired.

As explained in U.S. Pat. Nos. 10,665,118 and 10,967,894 of Island Radar, conventional track circuits typically extend up to several thousand feet away from a crossing in both directions, and are typically configured to activate active crossing warning systems with a pre-designated warning time of 20-30 seconds or 40-60 seconds based on crossing location and train speed. Track circuits operate on limited sections of railroad tracks via electrical connections to the rails of the tracks concerned. Track circuit techniques apply signals as a set of frequencies to the rails of each track and monitor a return signal path to detect a presence of a train. As the train is approaching the crossing, the conductive, metal axles at the front of the train electrically shunt or short the rails together and alter the spectral characteristics of the signals applied to the tracks. Accordingly, the frequency makeup of the signals from the tracks at the return path changes and the presence of the train can be detected. These changes provide the track circuit based train detection equipment in the railroad train detection system with an ability to determine how far away the approaching locomotive of the train is and also at what speed it is traveling. While effective to provide a 20-60 second warning time at the crossing, such 20-60 second warning time is woefully insufficient from a traffic control perspective wherein idled traffic at blocked crossings is desirably avoided. The third party supplied radar and infrared detectors may be placed outside the operating range of a track circuit to extend the warning time further (e.g., for an additional 20-30 second period) to accommodate higher speed trains, the total warning time (e.g., less than two minutes) is still nowhere near long enough to effectively reduce idled traffic at blocked crossings.

To some extent, traffic control measures are also possible with third-party train detection systems as further described in U.S. Pat. Nos. 10,665,118 and 10,967,894 of Island Radar. For example, Island Radar has proposed a train detection system that beneficially avoids unnecessary vehicle traffic disruption along roadways adjacent to railroad crossings but which do not themselves cross railroad tracks that are occupied by a train. Also, the associated traffic control improvements taught in U.S. Pat. Nos. 10,665,118 and 10,967,894 are generally limited to signalized intersections with adjacent roadways that are predominately found in higher traffic volume urban corridors. A large number of crossings without signal lights and/or without adjacent roadways exist in which such traffic control measures cannot be employed. More universally applicable traffic solutions are therefore desired.

For vehicles that do need to pass through the crossing, the systems of U.S. Pat. Nos. 10,665,118 and 10,967,894 will still operate shortly before the train arrives in a seemingly unpredictable manner to motorists at the crossing, and the amount of time that will be required for the train to clear the crossing is unknowable from the driver perspective. Improvements are accordingly desired that can operate with greater clarity and transparency from the driver perspective for both train arrival time and blocked crossing duration with an extended lead time for drivers and vehicle systems to proactively manage blocked crossing delays via enhanced notifications that, in turn, facilitate route selection and dispatching options that were not previously possible.

Both railroad-operated and third party train detection systems at crossing sites typically require continuously supplied hard-wired electrical power in order to reliably operate. Many railroad crossings exist, however, at locations where hard-wired electrical power at the site of the railroad crossing does not exist. Running electrical power cables to such railroad crossing sites is possible to retrofit a crossing with a third-party train detection system, but this is impractical in many cases, and as such existing third party train detection systems are limited in their application to only certain crossings where electrical lines already exist or can be economically provided. Especially for many rural, passive (non-signalized) crossings with no proximate commercial power and poor cellular data communications coverage, significant barriers to the use of conventional train detection systems exist.

Affordable third party railroad crossing notification systems are therefore desired that are not as dependent on conventional train sensors are more versatile for use at railroad crossing locations and that do not require extensive electrification at each electrical crossing in order to operate.

Mandated by Congress as part of the Rail Safety Improvement Act of 2008 (RSIA), railroad entities have largely implemented a Positive Train Control system (hereinafter “the PTC system”) across the nation's rail corridors. The primary objective of the PTC system is to prevent train collisions with one another, over-speed derailments, incursions into railroad worker zones, and movements of trains through switches left in the wrong position. The PTC system is implemented across a dedicated private radio infrastructure across more than 57,000 miles of main line track corridor operating on a licensed radio spectrum, with encrypted messaging and multiple wireless communication fallback systems to ensure reliable operation. Specifically, data communications in the PTC system are made via triple-redundant wireless communications from trains utilizing 220 MHZ and dual cellular system failover channels.

Railroad entity PTC systems must be sufficiently accurate and failsafe in order to maximize the safe operation of the nation's railroads. Real-time track corridor information is transmitted to locomotive onboard route computers and to railroad dispatch operation centers. In addition, locomotive location and operating metrics including, but not limited to, speed, length, and global positioning system (GPS) location are regularly transmitted to railroad dispatch centers via the PTC system. Constantly evaluated against the onboard route mapping systems, the PTC system enforces train speeds and can override train engineer actions to assure safe train operation, minimizing the possibility of train collisions and derailments.

As such, the PTC system is directed to railroad-entity interests concerning operation of the locomotive trains. The PTC system is not focused, however, on concerns for roadway vehicles (e.g., passenger cars and trucks, commercial vehicles, and emergency response vehicles) at blocked railroad crossings wherein a roadway intersects one or more railroad tracks. As noted above, railroad-operated crossing detection and notification systems with active warning features exist, which operate independently from the PTC system using sensors to detect trains as they approach each crossing, to protect the railroad's interests where the expense of installing and operating such systems is deemed justified by the railroad operator. The purpose and intent of such railroad-operated crossing detection and notification systems is to disrupt or block roadway traffic at the crossings in favor of safe passage of trains.

Because the railroad-entity centralized dispatch centers have real-time awareness of every train operating on PTC-enabled tracks, data and information collected by the PTC system could possibly be used to predict which railroad crossings are going to be occupied and for what duration without requiring any additional railroad equipment or third party equipment to physically detect train presence and movement at the site of each crossing. That is, train presence at crossings could be predicted based on train location, heading and speed known by the PTC system without utilizing a powered sensor system (either a railroad-based detection system or third party detection system) at the crossings. Such predicted arrival of the train at the crossing could in turn, facilitate control decisions to take appropriate measures at a crossing and/or to notify motorists of a blocked crossing in advance of the train's arrival at a crossing, both for safety concerns and for vehicle navigation concerns to reduce traffic disruption and traffic flow inefficiencies. This could be beneficial for crossings with and without active or passive crossing warning systems. Specifically, such predicted arrival of the train could be made with a longer lead time to make control decisions than existing train detection systems permit, or to facilitate control decisions based on train arrival information that was not previously available, including but not limited to vehicle routing decisions for passenger vehicles, commercial vehicles and emergency vehicles.

While the railroads have situational awareness of trains operating across their respective corridors via the PTC system, significant barriers exist to harnessing such awareness for predictive crossing notification purposes or for vehicular navigational aids, route optimization, and Emergency Medical Service (EMS) dispatching efficiency and for dispatching of other emergency responders (e.g., police and firefighters) for several reasons.

For many crossings along any given corridor train ETA prediction and blocked crossing duration prediction is of no practical interest to the railroad or the PTC system and as such these predictions are not generated by railroad operators. As such, for a host of crossings that presently exist, the PTC system does not include supporting data to simply or easily determine train ETA or blocked crossing duration estimates.

For certain crossings where train ETA information may be of interest to a railroad operator and is therefore known by a railroad operator, railroad entities are reluctant to provide crossing ETA information or supporting data for crossing ETA information out of concern for possible liability associated with any form of train-vehicle accident that may be associated with railroad-provided data. Railroad-entities are also understandably highly protective of train location information that could be used maliciously by any person or persons intent on disrupting rail transportation. Railroad entities are open, however, to providing minimum, basic data from PTC systems to third parties that do not raise liability concerns or security concerns to the railroad, but to date no one has overcome the significant obstacles that exist to reliably predict crossing ETA for trains and blocked crossing estimates for such a large number of trains captured on the PTC system headed toward disparate crossings on different sets of railroad tracks at any given point in time.

If the track distance between a current train location and a crossing could be accurately determined, an Estimated Time of Arrival (ETA) can be determined for the train to reach the crossing(s) ahead of it when the train location and train speed are each known. Of course, the train location and train speed are both known to the PTC system. The duration of the crossing blockage by the train can also be determined when the train length is known, which is also recorded in the PTC system. The general public, however, generally lacks train location information or train routing information to inform the analysis of estimated time of train arrival at a crossing with confidence. Indeed, and as mentioned above, the railroad operators prefer that specific train location data not be directly communicated externally from the PTC system in a manner that malicious actors could exploit. This considerably complicates any attempt to determine a track length (and travel time based on track length) between a current train location and any upcoming crossing.

Railroad tracks have conventionally included Mileposts that could be a basis to compute a track length between a current train location and any upcoming crossing, but in view of rail corridor modifications and optimizations the Mileposts in many cases are no longer reliable indicators of track length. Train ETA estimates that rely on Milepost data are therefore subject to error. Of course erroneous ETA estimates would present another form of traffic disruption and inefficiency, as well as safety concerns if motorists choose not to reply upon train ETA estimates that may be unreliable.

There are also practical challenges to the public in identifying the precise location of crossings along railroad corridors in which trains are operating. If either the beginning point (actual train location) or the ending point (the crossing of interest) cannot be reliably determined, a reliable train ETA or blocked crossing duration estimate cannot be determined for any particular crossing.

Affordable, effective and reliable railroad crossing notification system improvements are therefore desired that improve crossing safety without necessarily relying upon conventional train detection sensors at the site of a railroad crossing or throughout a corridor extending out and away from respective railroad crossings, that do not require extensive electrification at each electrical crossing in order to operate, and that facilitate proactive crossing management for vehicle routing purposes to reduce inefficiencies and traffic disruptions at railroad crossings.

### II. Inventive Predictive Crossing Systems and Methods

Inventive embodiments of independent third party, non-railroad data-driven predictive railroad crossing safety notification and vehicle traffic management systems and methods are described below which overcome the numerous technical problems and issues described above. The inventive systems and methods advantageously realize lower cost yet reliable crossing safety notification system improvements at a significantly greater number of railroad crossings while also intelligently realizing substantial traffic control system improvements at railroad crossings that may be implemented in a versatile manner across existing railroad crossings without restriction.

Operating upon a subset of data and information maintained by railroad centralized dispatch centers through their respective PTC systems, railroad or third party operated train detection systems and/or radio communication data associated with PTC systems and third party train detection systems train ETA and blocked crossing time estimation is meaningfully provided by the inventive systems and methods for the benefit of improved railroad crossing safety, vehicle navigational aid, route optimization systems, Traffic Message Channel system communications, and EMS routing. Additionally, active crossing warning systems may be activated (as enhancements to existing railroad-owned crossing warning systems or to existing crossing where only passive warning systems are in place, or as stand-alone retrofit systems to crossings having no active or passing warning system in place), roadside signage may activated, in-auto driver alerts may be delivered, and alerts may be received by personal devices of non-drivers. Communications and messaging, including alternate route information to avoid blocked crossings and associated travel delays to reach a destination, are synthesized across a variety of platforms to maximize system and method versatility to reach as many interested persons as possible.

The inventive systems and methods described herein provide accurate train ETA and blocked crossing time estimation for trains that are, for example, at least 10-20 miles away (or further) from crossings of interest. This in turn, means that the inventive systems and methods can effectively provide at least 10-20 minutes (or longer) lead times to notify vehicle systems, traffic systems, and personal devices, for example and allow vehicle systems, operators, drivers, and persons ample lead time to make decisions and take needed actions to avoid blocked crossings. Significantly, extended lead times of at least about 10 times to more than 100 times of existing railroad-operated train detection systems which provide a lead time in a range of 20-60 seconds systems provides for proactive management of train arrival and blocked crossing probabilities that was not previously possible.

In the inventive systems and methods of the invention, technical complexities of resolving ambiguities in data that railroad entities are willing to share are solved for the significant benefit of conveying real-time transparency in expected crossing blockages by trains and expected durations of blocked crossings by trains in a manner that heretofore has not been possible. As such, technological solutions to technological problems in the railroad industry and in the vehicle navigation and vehicle dispatch industries are realized by the inventive systems and methods of the invention in a manner that is neither routine or conventional in the pertinent field of endeavor. Predictive blocked crossing information is not only reliably generated to solve technical problems and drive technical improvements, but the predictive blocked crossing information is integrated into numerous practical applications in real-world devices and systems.

The systems and methods described below advantageously provide accurate, real-time information regarding impending train arrival at active or passive, public or private railroad crossings. Such real-time information can, in turn, facilitate traffic proactive control decisions to improve crossing safety and reduce traffic idling at crossing. Vehicle route optimization options are made possible by predictive train ETA and blocked crossing estimates, opportunities for train-automobile accidents are reduced, active lighted or audible train arrival signage at previously passive crossings is possible, communications of impending train arrival information can be made to vehicle-based alert devices or systems, and emergency vehicle dispatch control decisions can be made to improve response time and avoid delays.

For example, predictive train ETA and blocked crossing estimate information may by output in systems and method of the invention to facilitate more optimal decision making in GPS Navigation systems that provide route optimization features (e.g., Waze, Garman, TomTom, Sirius). Emergency dispatch operation centers, Traffic Message Channel providers (RDS, Sirius), and Intelligent Transportation Systems (ITS) for conveyance through Infrastructure to Vehicle (12V) subsystems may also benefit from predictive train ETA and blocked crossing estimate information. Motor vehicle operators may proactively alter their routes prior to train arrival at a crossing to avoid delay with advanced knowledge of predictive train ETA and blocked crossing estimate information. Optimized routes enabled by the predictive train ETA and blocked crossing estimate information, in turn, beneficially reduce adverse environmental effects caused by idling traffic at crossings. Millions of hours per year of idled vehicles at railroad crossings can beneficially be reduced.

For the benefit of the railroad industry, informing drivers ahead of time about impending crossing activations by the systems and methods of the invention advantageously empowers drivers to consider taking different routes to avoid crossings when trains are present. By reducing instances that vehicles and motorists are at the same crossings at the same time, a likelihood of train-vehicle collisions is inherently reduced, and railroads may operate with an increased degree of safety and efficiency.

Predictive train ETA and blocked crossing estimate information generated by the systems and methods of the invention further facilitates an optimization of emergency dispatch and routing to minimize a likelihood, for example, that fire and EMT response personnel are not unnecessarily delayed by trains arriving at crossings in an unexpected manner. EMS dispatch efficiency can therefore be significantly improved.

In some beneficial aspects of the present systems and methods, at passive crossings where there are no track circuits or commercial power to utilize active crossing warning systems, time-of-arrival information derived from real-time PTC data can be used to activate lighted, solar-powered signage, thereby advising motorists in rural areas and at private passive crossings of impending train arrival at those crossings. Locally broadcasted train arrival information can also be transmitted to automotive ITS (Intelligent Transportation Systems) using Dedicated Short Range Communication Systems (DSRC) systems and to other in-car alert devices utilizing, for example, low-power Bluetooth and other communication technologies.

The real-time and real-world, end use applications of the systems and methods of the invention as summarized above are enabled by predicting crossing activation time and duration, and synthesizing information including, with accounting for changes in train speed over time: (i) estimated times of crossing activation (and hence, roadway blockage) for a number of trains operating at any given time with respect to associated crossings that the trains are approaching; (ii); estimated duration of crossing activation (based on train velocity and train length) at specific crossing locations; and (iii) communicating estimation data to specific systems and devices at the locations of each affected crossing (i.e., roadway/railroad intersection) of interest and to vehicles and systems for vehicles in the general vicinity of crossings of interest to assess route impact and options for enhanced routing to avoid blocked crossings, including for example only GPS location data of particular crossings, cross street data, Municipality and State data, etc.

In contemplated embodiments, basic information that railroads are willing to share for the purposes of the inventive systems and methods includes for example, on ten-minute update intervals: (i) Current train location data by Division, Subdivision, Branch, and Milepost of particular railroad corridors; (ii) Train speed and heading; and (iii) Train length. Instead of making such data generally available to the public, however, railroads are willing to provide such data, and only the minimum data necessary, on the condition that it is made available only to a trusted broker, or intermediary system, which can consume PTC-sourced train information from multiple railroads, appropriately anonymize the train data, and securely distribute the information as necessary to the end applications such as those described above and below.

Operating as a trusted broker node interfaced with PTC systems of railroad operators, a railroad-independent system configured as a computer server in contemplated embodiments of the inventive systems and methods, resolves and delivers train ETA and blocked crossing duration information for use by vehicle navigational aid systems and other important dispatch systems and notification devices. Such resolutions and delivery of train ETA and blocked crossing duration information is accomplished via correlating railroad-provided train location speed, length and heading with information maintained by other databases (for instance the Federal Railroad Administration's Crossing Inventory Database) that provide static crossing location information for a vast number of public or private crossings in terms of GPS coordinates, Division/Subdivision/Branch/Milepost, Cross-streets, and Municipality. Speed and heading information provided by the railroad PTC database allows the trusted broker node to calculate time of arrival at a crossing, by converting Milepost data to their GPS equivalents. Train length and speed information can be used to calculated expected duration of crossing blockage that may be expected once the train has reached the crossing island. Frequent updates (in a range of two to ten minutes for instance) can continuously correct for variances in train velocity along the route.

Once the train arrival time at identified crossings is determined along with the estimated time a locomotive will block each crossing once it arrives, this information may be used for purposes beyond alerting drivers of traffic blockage at crossings through navigational aids. For example, and as previously mentioned, such information may be communicated to local emergency vehicle dispatch centers which can then be sure the chance emergency vehicles may be slowed or halted can be minimized.

In another aspect of the inventive systems and methods, the thousands of rural crossings that do not have electricity or railroad infrastructure to support active crossings (lights and gates) can be outfitted with lighted signage that will alert drivers to the impending arrival of trains at each crossing in real-time. For example, information pertaining to the impending arrival of a train at a rural, passive crossing, can be communicated over secure cellular radio (5G for instance) which will then activate LED warning lights on signage proximate to the crossing to warn of the possible arrival of a train. The radio receiver and lighted signage equipment can be powered by solar panels with battery backup for use at crossings which do not have any nearby source of electrical power. Such electronic signage communicating train ETA and blocked crossing duration information also presents value added functionality to existing active warning crossing systems that do not have any predictive capability or ability to determine blocked crossing duration via the railroad-owned track circuit based sensor systems provided for the purpose of crossing warning system activation.

In other aspects of the inventive systems and methods numerous metadata can utilized dynamically to measure the overall reliability of the systems and methods in generating and communication accurate train ETA and blocked crossing duration estimates. Such metadata includes (i) GPS data from the railroad and from the FRA crossing inventory database which can also be used to dually validate locations of interest; (ii) actual train arrival (at a crossing) information can be used to constantly measure the accuracy of the system; and (iii) using machine learning, repetitive routes by the same trains can be “learned” by the system to constantly improve accuracy of predictive train ETA and blocked crossing duration estimates. As such, the systems and methods in these aspects defined improvements in the functioning of intelligent devices which determine the train ETA and blocked crossing duration estimates.

Turning now to the figures, exemplary embodiments of the systems and methods implemented with intelligent, networked, processor-based devices, systems and subsystems are described below. As used herein, the term “processor-based device” shall refer to computers, processors, microprocessors, microcontrollers, microcomputers, programmable logic controllers, reduced instruction set (RISC) circuits, application specific integrated circuits and other programmable circuits, logic circuits, equivalents thereof, and any other circuit or processor capable of executing the functions described below. The above examples are exemplary only, and are thus not intended to limit in any way the definition and/or meaning of the term “processor-based device”.

The systems and processes of the present invention may be implemented as described in the following examples with one or more interfaced intelligent systems and processor-based devices including a microcomputer or other processor, and a memory that stores executable instructions, commands, and control algorithms, as well as other data and information required to satisfactorily operate the systems to realize the desired functionality described herein. The memory of the processor-based device may be, for example, a random access memory (RAM), other forms of memory could be used in conjunction with RAM memory, including but not limited to flash memory (FLASH), programmable read only memory (PROM), and electronically erasable programmable read only memory (EEPROM). Method aspects of the intelligent, networked, processor-based devices, systems and subsystems are in part apparent and in part explicitly discussed in the following description.

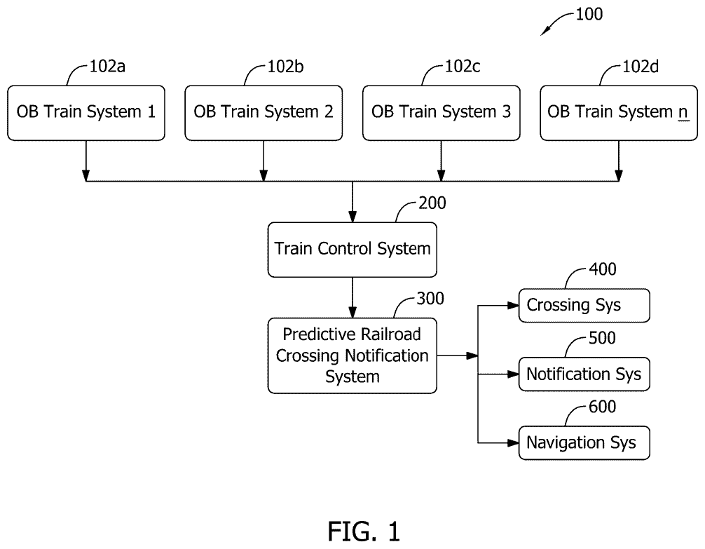

FIG. 1 is a block diagram of a computer-implemented predictive railroad crossing notification and traffic control system 100 according to a first exemplary embodiment of the present invention.

The system 100 is shown in FIG. 1 to include a plurality of onboard train systems 102a, 102b, 102c, 102d. Such onboard train systems 102a, 102b, 102c, 102d include sensors and controls that report a variety of detected information concerning the operation of a locomotive, the most pertinent of which for purposes of the present invention is train speed, train location, and train length that are each respectively reported to the train control system 200, which may be the Positive Train Control (PCT) system in an exemplary embodiment or another train control system that collects train operation data and information via means other than PTC enabled railroad tracks. The train systems 102a, 102b, 102c, 102d are generally known and for the sake of brevity are not further described herein, but such onboard train systems are realized via intelligent processor-based controls and computers that comprehensively monitor the operation of the train and communicate a host of data concerning the train operation via wireless connection to the control system 200 according to known radio frequency communication protocols.

The train systems 102a, 102b, 102c, 102d may correspond to different trains of the same railroad entity or to a combination of trains operated by different railroad entities. The system 100 is scalable to include reports from practically any number n of onboard train systems reporting to the train control system 200. When needed, the train control system 200 may issue override instructions responsive to contrary instructions issued to or generated by the onboard train system 200, with such override instructions communicated wirelessly from the train control system 200 to the respective onboard train systems 102a, 102b, 102c, 102d to ensure railroad safety and enforce speed limits or other concerns as applicable individually to the trains represented by the train systems 102a, 102b, 102c, 102d. The train control system 200 may intelligently oversee large numbers of trains operating in different areas. The train control system 200 is implemented in intelligent processor-based controls and computers at centralized location(s).

The train systems 102a, 102b, 102c, 102d are railroad operated and present the data and information from the train systems 102a, 102b, 102c, 102d which is not publicly available. The data and information in the train system 200 is likewise proprietary data and information of a railroad entity and is not publicly available data. In the system 100, however, the train control system 200 is in communication with an authorized, trusted predictive railroad crossing notification system 300 which advantageously determines train ETA and blocked crossing duration estimates based in part on train location data collected from the train control system 200 while appropriately safeguarding railroad interests and insulating them from reliability concerns. Such an authorized, trusted interface between the train control system 200 and the predictive railroad crossing notification system 300 advantageously renders it possible to provide train ETA and blocked crossing duration estimates universally to any crossing, and particularly to the many crossings that today lack any train sensor system or active warning system.

While GPS coordinates of each locomotive are known by each train system 102a, 102b, 102c, 102d railroad entities are reluctant to make them known as such simple disclosure of precise train location could potentially be exploited by malicious actors. In view of this, railroad entities would prefer to release other location data that can be indirectly used to determine train location in order to facilitate the desired train ETA and blocked crossing duration estimates. Such indirect determinations are a bit cumbersome but possible.

Apart from the GPS coordinates of the locomotive themselves, other location data on railroad corridors that is collected by the PTC system relates to the track(s) on which each train is travelling. Specifically, track locations are identified by Track Segment (including Division, Sub Division and Branch) and Milepost. Mileposts are historically standard points on a railroad's track infrastructure, and originally designated an actual distance (typically in tenths of mile) between contiguous Mileposts along the corridor. However, as railroads continue to optimize track corridors, for instance by straightening curves, building bridges, and creating tunnels, Milepost numbers have ceased to be representative of actual distance between Mileposts.

For example, a track section that originally included a long curve section might have had Mileposts that were numbered 48.1 and 52.5 at the ends of the curve section. In this example, the curved track distance between those Mileposts would have actually been 4.4 miles. But after the railroad straightened this curved track section to optimize the corridor, the actual track distance between the same Mileposts could be reduced to 3.0 miles. Because of all the hardcopy and electronic records associated with the Milepost locations and the various railroad assets along the corridor, the railroad would not rename/renumber these Mileposts as it would then require every Milepost before and after the curve to also be renumbered to realize accurate incremental distance along the entire corridor post-modification of the original curved section. To solve this problem, GPS coordinates have been assigned to the existing Mileposts because the original Milepost data points (reflecting the mileage from a predetermined starting point) may or may not be true indicators of track length between Mileposts or of a cumulative distance from the predetermined starting point along the railroad corridor.

The conversion of Mileposts to GPS coordinates makes it possible, but cumbersome, to indirectly determine an actual track distance between two points along the corridor (e.g., the current location of the train and a crossing ahead that the train is approaching) from the GPS coordinates of the mileposts located between the two points. A cumulative assessment of GPS coordinates between contiguous mileposts along the corridor is needed, however, and ambiguities will need to be resolved with route mapping information. For instance, the GPS coordinates themselves will not convey, for example, whether the track is straight or curved between any two Mileposts. Considering the previous example wherein a 4.4 mile long curved section was modified to a 3.0 mile long section via straightening of the track, the GPS coordinates of the associated Mileposts alone would not infer the correct track length distance between them.

In view of the above, simple mathematical operations on the GPS coordinates without accounting for actual route information may produce a mathematical track length that deviates from the real-world track length. Such errors may cascade along a route corridor and produce corresponding error in any attempt to predict train arrival at a crossing. The greater the deviation between predicted arrival times and actual arrival times, however, the greater the temptation for drivers to disregard such prediction, rendering such predictive estimates counterproductive. As described further below, however, exemplary embodiments of the system of the invention operates with respect to detailed crossing information and railroad routing information to determine accurate track length distances in combination with the Milepost data. The accurate track length distance can then be utilized with train speed and train length data reported by the train control system 200 to determine train ETA and blocked crossing estimates at various different crossings as further described below.

The system 100 is implemented in intelligent processor-based controls and computer devices, some at centralized location(s) and other dispersed at remote locations to one another and with respect to any centralized system(s) as further described below. Given the number of trains in operation, the number of railroad corridors for operating trains to run on, and the sheer number of crossings across the nation, more than one system 100 and/or more than one predictive railroad crossing notification system 300 could be provided to serve railroad traffic and roadway traffic in designated geographic areas, with each system 100 or 300 operating to produce train ETA and blocked crossing estimates for a smaller number of trains and a smaller number of crossings within predetermined geographic boundaries.

In contemplated embodiments of the system, train control system data is sampled periodically on a predetermined frequency (e.g., about every two minutes to about every ten minutes to meet particular needs) and train ETA's and blocked crossing estimates can be recalculated and recommunicated over time. This provides capability for intelligent machine learning and adjustments in determined train ETA's and blocked crossing estimates as real-world conditions change. For example, the system can methodically compare previously calculated train ETA's and blocked crossing estimates to prior calculated values, and based on the analysis of data over time the system may become probabilistic in its determinations of train ETA's and blocked crossing estimates for various different crossings over time. Patterns in train movements may be identified and factored into estimates generated.

As one example, when the estimates are generated every ten minutes, six estimates may be generated for a crossing in a one hour period when the train is sufficiently far away and/or travelling at a speed that the train will not reach the crossing in a one hour period. Hypothetically, the train ETA estimates for the same crossing over a one hour period may differ as follows beginning at an initial time to of 12:00 pm. At time to the train ETA may be one hour or at 1:00 pm. Ten minutes later at time to the train ETA may be one hour from time to or 1:10 pm. Another ten minutes later at time t₂ the train ETA may be one hour from time t₁ or 1:20 pm. Another ten minutes later at time t₃ the train ETA may be one hour from time t₃ or 1:30 pm. Another ten minutes later at time t₄ the train ETA may be one hour from time t₄ or 1:40 pm. Another ten minutes later at time t₅ the train ETA may be one hour from time t₅ or 1:50 pm. This pattern of increasing train ETA over time indicates that the train speed has been slowing down over the last 50 minutes. If this is identified as a repeated pattern from the data collected over time in the same general time period on different days, the predictive railroad crossing notification system 300 could override the next time to estimate from 1 hour to 1 hour 50 minutes and adjust the estimates at times t₁, t₂, t₃ and t₄ so that the earlier estimates will match the last t₅ estimate.

In other examples, the system could identify patterns in the data where the train speed is increasing and estimated train ETA is growing smaller over time. In such a case, the predictive railroad crossing notification system 300 may adjust or reduce earlier estimates where the train is initially operating at a lower speed initially but arrives at the crossing with a higher speed. As another example, the system could identify a pattern in the data where the train speed is reducing and estimated train ETA is increasing over time, and in response the predictive railroad crossing notification system 300 may adjust or increase earlier estimates to account for the slowing of the train.

With such pattern recognition in the data and adjusting earlier ETA estimates to converge toward later ETA estimates in the patterns, the predictive railroad crossing notification system 300 could intelligently infer and account for under and over-estimation of ETA at each iteration to adjust ETA values at certain iterations to more probable values based on convergence in prior system data. While a predetermined sampling frequency of ten minutes is believed to be appropriate in providing enough data to make reliable estimates without overtaxing the system, both longer and shorter sampling frequencies are possible in further and/or alternative embodiments. Increasing or decreasing the sampling frequency in the aforementioned range of about two to about ten minutes may, in turn, result in varying degrees of sophistication and functionality based on different sets of different data.

Once train ETA and blocked crossing duration estimates are generated by the predictive railroad crossing notification system 300, they are communicated wirelessly to a respective crossing device or system 400 at one or more of the crossings to warn drivers at the crossing location of an approaching train at the crossing, to a respective notification device or system 500 to warn one or more persons (e.g., drivers, railroad workers at a crossing or pedestrians) of the approaching train, and to respective vehicle navigation devices or systems 600 to assess and consider possible route impact for routes in progress, or to assess alternative route options for new routes (i.e., routes that have not yet been started) to avoid delay of a train passing through the crossing. The devices or systems 400, 500, 600 are implemented in intelligent processor-based controls and computer devices as further described below.

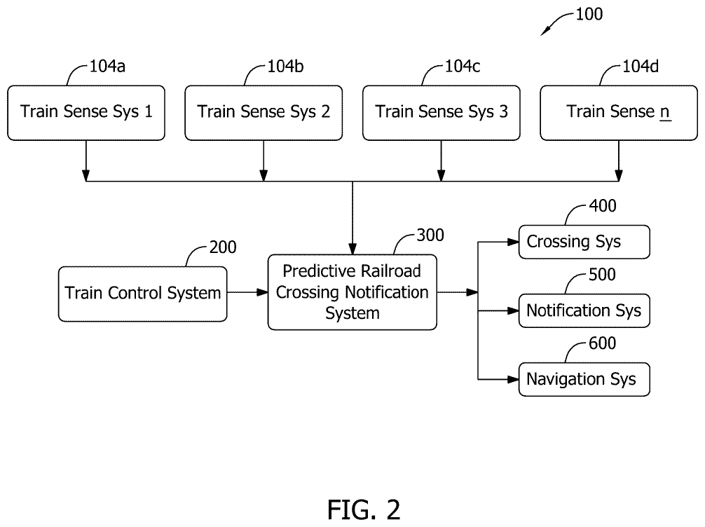

FIG. 2 is a block diagram of the predictive railroad crossing notification and traffic control system 100 according to a second exemplary embodiment of the present invention that includes train sensing systems 104a, 104b, 104c and 104d. The train sensing systems 104a, 104b, 104c and 104d may be conventional crossing detection systems operated by the railroads or third parties at the site of specific crossings. Sensed train data from the systems 104a, 104b, 104c and 104d can be communicated to the predictive railroad crossing notification system 300, and provide a basis to evaluate the accuracy of predicted train ETA or estimated blocked crossing duration at the crossings where they operate. The systems 104a, 104b, 104c and 104d therefore provide a feedback loop to confirm an accuracy of predicted train ETA or estimated blocked crossing duration by the predictive railroad crossing notification system 300 which derives the estimates from data and information of the train control system 200. The feedback loop also provides for intelligent machine learning capabilities to adjust predicted train ETA or estimated blocked crossing duration in real-time as real-world conditions change.

For example, and in addition to comparing previously determined train ETA's and blocked crossing estimates as described above, the sensed train data from systems 104a, 104b, 104c, 104d may provide a further basis for probabilistic determination of train ETA's and blocked crossing estimates once a sufficient amount of data is collected and compared. For example, if train ETA estimates for a given crossing deviate 10% from actual time (as determined by systems 104a, 104b, 104c, 104d) of trains reaching the crossing, the system can begin to automatically add or subtract 10% as applicable to the estimates until the estimate times and actual times converge at the same value. This is another aspect of a self-learning or self-adjusting behavior of the system to generate reliable train ETA and blocked crossing duration estimate data. As such, while the systems 104a, 104b, 104c, 104d are only present at a subset of the railroad crossings that exist, they can serve as reliable and supplemental data points to make reliable train ETA estimates and blocked crossing estimates at crossings that do not include systems 104a, 104b, 104c, 104d. The system is scalable to include any number of systems 104a, 104b, 104c, 104d.

In another aspect, the train sensing systems 104a, 104b, 104c, 104d could provide sufficient data upon which the predictive railroad crossing notification system 300 could operate independent of a train control system such as the aforementioned PTC system. Considering that some existing train sensing systems 104 are capable of determining train speed and train length at known locations, they could provide data inputs for the predictive railroad crossing notification system 300 to generate train ETA estimates or blocked crossing duration estimates for subsequent crossings approached by the train in any specific railroad corridor.

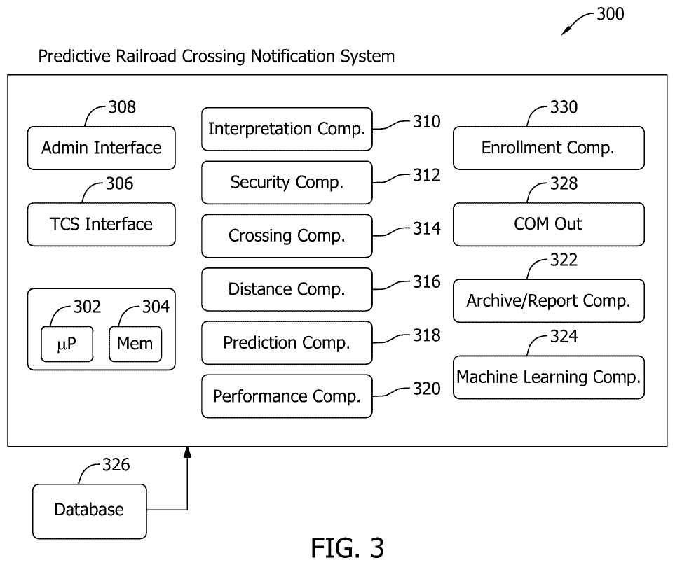

FIG. 3 is a block diagram of the predictive railroad crossing notification system 300 in an exemplary embodiment. In contemplated embodiments, the predictive railroad crossing notification system 300 is configured as one or more computer servers including a processor 302 and a memory 304.

The predictive railroad crossing notification system 300 includes a Train Control System (TCS) Interface 306 for receiving data and information from the train control system 200 (FIGS. 1 and 2). In different embodiments, the TCS Interface 306 may be realized through wired and wireless connections, including but not limited to radio frequency signal transmission and cellular signal transmission of data and information, and networked computer connections including but not limited to the Internet. Data from the train control system 200 may be periodically output and received by the predictive railroad crossing notification system 300 and/or may be periodically queried and retrieved from the train control system 200 for purposes of the system 300. The predictive railroad crossing notification system 300 may also include an administrative interface 308 for predictive railroad crossing notification system operators and personnel to set system preferences, register users and enroll devices to receive notifications, manage notifications, perform updates, review activity logs and generate reports, and to implement other preferred features for use.

The predictive railroad crossing notification system 300 in the example shown includes a variety of components including interpretation components 310, security components 312, crossing components 314, distance components 316, prediction components 318, performance components 320, archiving and reporting components 322, and machine learning components 324. Each of the components 310 through 324 may be implemented in hardware, software or firmware components operable with respect to machine readable language or code segments executable by the processor to realize the functionality described herein.

The interpretation components 310 receive data and information from the TCS interface and perform any filtering, reformatting or processing needed of the TCS data to realize the functionality described herein. In some embodiments, the interpretation components 310 could be considered optional and need not be included.

The security components 310 anonymize data from the train control system 200 that could otherwise be exploited for malicious purposes. As such, train identification data and route identification data, for example, is removed from associated data streams when needed. In another case, anonymized data from the train control system 200 may be received from the train control system 200 instead of being produced in the security components. Regardless, any data output by the system 300 concerning train arrival or blocked crossing duration estimate therefore will relate to a generic train arrival event rather than to a specifically identified train along a specific route that is operated by a specific railroad operator. Also, the security components 312 may include decryption components for data and information sent to or received by the system 300, as well as to facilitate encrypted communications and the like for data sent from or retrieved from the system 300 as safeguards to protect data inputs and data outputs from access by unauthorized persons.

The crossing components 314 identify, based on train location data received from the train control system 200, railroad crossings in the track corridor ahead for which train ETA and blocked crossing duration estimates are desired. The crossing components operate specifically train-by-train that are traveling on the same or different corridors, and the crossings identified may cross the same or different railroad tracks in different segments of rail corridors or in different corridors entirely. The crossing components 314 may operate with respect to a database 326 including railroad routing and crossing information. By correlating train location information with such routing and crossing location information in the database 326, the system 300 can identify a plurality of crossings along the route for which train ETA and blocked crossing duration estimates may be desirably generated.

In contemplated embodiments, the identified railroad crossings may be geographically limited to crossings within a predetermined distance (e.g., 25-50 miles of the actual train location of each operation train). The predetermined distance may be extended for higher speed trains or reduced for lower speed trains. Depending on the specifics of the railroad corridors, the number of crossings identified may also be limited by the system 300 (e.g., estimates may be provided for the next 5 crossings) rather than being limited by distance-based limits. In other embodiments, identified crossings can be limited to those inside the boundaries of governmental entities such as towns, cities and municipalities as non-limiting examples. Other boundaries such as dispatch service boundaries, delivery service boundaries, etc. may also be used to limit the number of crossings for specific public or private concerns. Geofencing and other boundary setting techniques are possible that do not necessarily correspond to governmental interests or entities to limit the number of crossing considered by the system for particular end uses or end users. Outside of certain limits, train ETA and blocked crossing duration may become impractical for crossings that are too far removed from present train locations, but in some embodiments such limitations may be considered optional and need not be utilized.

The distance components 316 determine the distance between the train location data for each operating train and each of the crossings identified. Specifically, the distance components 316 operate on the Milepost data in the train location data in order to determine the track length distance between the Milepost location of the train and one or more crossings along the route that the train is moving toward. Milepost and routing information in the database 326 may be accessed to assess track distance Milepost-by-Milepost using converted Milepost to GPS data and actual track configuration data (e.g., straight versus curved track) to accurately account for railroad track modifications and optimization of rail corridors. In some embodiments, lookup tables may be generated and utilized by the system in determining distances. The distances are determined individually for each train to the respective crossings of interest, which may or may not have any independent ability to physically detect a train at the crossing.

The prediction components 318 determine the train ETA of each operating train at each of the identified crossings. The ETA determination may include dividing the distance value by the corresponding train speed data value for each of the identified crossings for the respective trains. Crossing-specific train ETA's are therefore generated for each train and each of the crossings approached. In some embodiments, lookup tables may be generated including train ETA values for train location, train speed and distance to crossing values, or ETA values for specific crossings based on train location and speed.

The prediction components 318 also determine crossing blockage duration values based on train speed and train length data and information from the train control system 200. For example, the blocked crossing duration is a function of train length divided by train speed. Lookup tables and the like can also be used to determine the blocked crossing duration estimate for a given train speed and length.

Consider, for example, a first train that is located 10 miles (52,800 feet) from a first crossing of interest, travelling at a speed of 45 mph (66 feet per second), and having a length of 6500 feet. The estimates may be determined as follows by the system 300. The train ETA is the distance divided by the train speed, or 52,800/66 or 800 seconds (13.3 minutes). The blocked crossing duration once the train arrives is the train length divided by the train speed or 6500/66 or about 98 seconds (1.63 min). Each of these estimates could be correlated with the time of the last train location report. As such, and following this example, if the train location was last reported at 12:00 pm the output of the system 300 may communicate a train ETA of 12:13 pm (12:00 plus 13 minutes for it to arrive at the crossing) and blocked crossing until 12:15 pm (train ETA of 12:13 plus blocked crossing duration of 1.63 minutes).

The reader may recognize from the above example that for a second crossing of interest located 20 miles away for the same train, the train ETA for the second crossing is about double the first, so the train ETA at the second crossing would be 12:26 pm with crossing blocked until 12:28 pm. This means that for motorists in route at 12:00 pm heading toward the same crossings, the system 300 may provide up to 13 minute and 26 minute lead times for drivers and/or vehicle systems to anticipate and avoid blockages at the respective first or second crossings.

Also consider a second a train located 15 miles (79200 feet) from a third crossing of interest travelling at a speed of 30 mph or 44 feet per second and having a length of 14000 feet. The estimates may be determined as follows by the system 300. The train ETA is the distance divided by the train speed, or 79200/44 or 1800 seconds (30 minutes). The blocked crossing duration once the train arrives is the train length divided by the train speed or 14000/44 or about 318 seconds (5.3 min). This could be correlated with the time of the last train location report. As such, and following this example, if the second location was last reported at 12:00 pm the output of the system 300 may communicate a train ETA of 12:30 pm (12:00 plus 30 minutes for it to arrive at the crossing) and blocked crossing until 12:36 pm (train ETA of 12:13 plus blocked crossing duration of 5.3 minutes).

The reader may recognize from the example above that for a fourth crossing of interest located 30 miles away for the same train would result in a train ETA for the fourth crossing that is about the double the estimate for the third crossing, so the train ETA at the fourth crossing would be 1:00 pm with crossing blocked until 1:06 pm. This means that the system 300 may provide up to 30 minute and 1 hour lead times for drivers and/or vehicle systems to anticipate and avoid the blocked crossing.

It should be realized that the system 300 simultaneously provides estimates such as those above for the first and second trains respectively moving toward the first, second, third and fourth crossings. By extension, the system simultaneously provides estimates for all operating trains and all identified crossings for the trains that are operating. This is contrasted with conventional train detection systems that physically sense train arrival only at crossings where trains are actually arriving with no prior knowledge of a train on approach. In other words, conventional train detection systems detect trains one at a time when actually present at specific crossings where the conventional train detection systems are installed, whereas the system 300, via the estimates generated, operates across multiple trains and multiple crossings (regardless of whether the multiple crossings including any train detection capabilities), enabling capabilities that conventional train detection systems simply cannot realize.

Train ETA and blocked crossing estimates may be provided by the system 300 with crossing-specific information with varying amounts of lead time for oncoming vehicles to each crossing, but with sufficient lead time for drivers and vehicle systems to change routes in order to avoid a traffic delay at one or more of the crossings. In contemplated systems, data and information from the train control system 200 is evaluated periodically (e.g., about every ten minutes) so a vehicle that is travelling along a route at a rate that places it about one hour away from a crossing may be given six opportunities in the ensuing hour to take actions to avoid the blocked crossing. As another example, when data and information from the train control system 200 is evaluated periodically (e.g., about every two minutes) a vehicle that is travelling along a route at a rate that places it about one hour away from a crossing may be given thirty opportunities in the ensuing hour to take actions to avoid the blocked crossing. Such action taken to avoid the blocked crossing may include altering the vehicle speed, changing the vehicle route, opportunistically refueling the car, or taking a break in a manner that avoids arriving at the crossing while the train is there to block the crossing. The driver may avoid idling at the railroad crossing waiting for the train to pass and any inconvenient delay in travel associated with the blocked crossing.

The periodic sampling and evaluation of the system 300 improves accuracy of the estimates provided. For example, if the train changes speed between sampling periods the new speed and location data captured at the next sampling interval will trigger a re-calculation of train ETA and blocked crossing duration. Monitored over the course of an hour, for example, the iterative data sampling and calculations that are refined about six times (or more) before the train actually reaches a given crossing will mean progressively more accurate estimates that account dynamically for changes in train speed over the last hour. As such, the system could determine but not report earlier estimates that may not be accurate in favor of reporting later determined estimates having a higher degree of accuracy. A sampling frequency of greater or less than 10 minutes is possible and may be utilized in other embodiments of the system.

Machine learning components 324 analyze estimates produced by the system 300 and improve ETA and blocked crossing duration estimates even further. For example, current estimates may be compared to prior estimates, and patterns may be deduced that may desirably lead to adjustments in the estimates generated at each iteration. For example, if the components 324 identify an over-estimation or under-estimation of a current estimate relative to prior estimate, an over-estimation or under-estimation of a prior estimate, or a pattern of over-estimation or underestimation that may occur for certain crossings, appropriate adjustments can be made to the current estimates to compensate as described above. As one example of this type of adjustment, calculated estimates or values in lookup tables may be adjusted up or down for certain crossings based on prior estimates for the same crossing. Such adjustment could further be informed by train sensing data from the systems 104a, 104b, 104c, 104d (FIG. 2) that may be compared to estimates generated and provide a further basis for machine learning to progressively determine more reliable estimates over time.

Archiving and reporting components 322 allow for diagnostics and troubleshooting of the system 300, and may be accessed by the machine learning components 324 for review and analysis. Human operators and overseers may also access the archiving and reporting components 322 for system oversight through the administrative interface 308.

The predictive railroad crossing system 300 also includes a communications interface 328 for outputting data to devices and systems such as those described below with significant benefits. Communications of data outputs may occur wired or wirelessly utilizing suitable communication protocols.

Enrollment components 330 are also optionally included in some embodiments. The enrollment components 330 allow for enrollment or registration of specific devices that the system 300 is to communicate with in specific formats or protocols pertinent to each specific device. Such specific devices, referred to herein as receiver devices may be identified in the enrollment components with supporting data to allow targeted messaging capability to each receiving device. As such, the system 300 is capable of selectively communicating with some connected devices but not others at any given point in time. As such, the applicable receiving device may receive output prediction information that specifically applies to such receiving devices, while other receiving devices operating in areas with no current train ETA estimates or blocked crossing estimates will not receive crossing status and estimate information. The system 300 is therefore beneficially able to communicate with selected receiving devices on a need to know basis to evaluate actions (e.g., alerts, suggested route changes, etc.) to avoid blocked crossings and improve crossing safety via advance notice of predicted train arrival.

In some contemplated embodiments, the enrollment components may also include authorized user information and authorized user device information for personal devices and the like. The enrollment may also include township, municipality, and city information to provide targeted services to crossings located in or overseen by specific entities, or to offer different levels or degrees of service to provide more or less sophistication of notification, alerts and suggestions for alternate routes and detours for specific entities, specific end application and specific users, for example. Boundary information such as that described above may be defined in the enrollment components for certain applications and certain users. Within boundaries, crossing-specific enrollment decisions may be made, wherein some crossings may be enrolled for the services of the system 300 while other crossing are not enrolled. Enrollment information may include contact information and billing or payment information in some cases. Whether paid or not, subscription type-services for only authorized users and authorized devices provides another safeguard against improper access and use of data outputs by the system, as well as improved record keeping regarding specific communications made by the system over time.

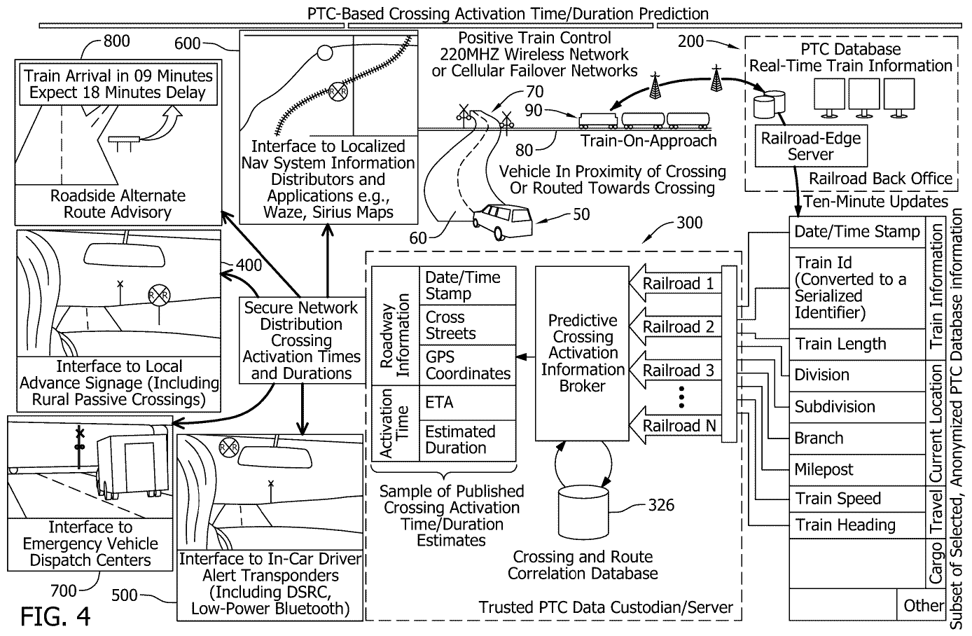

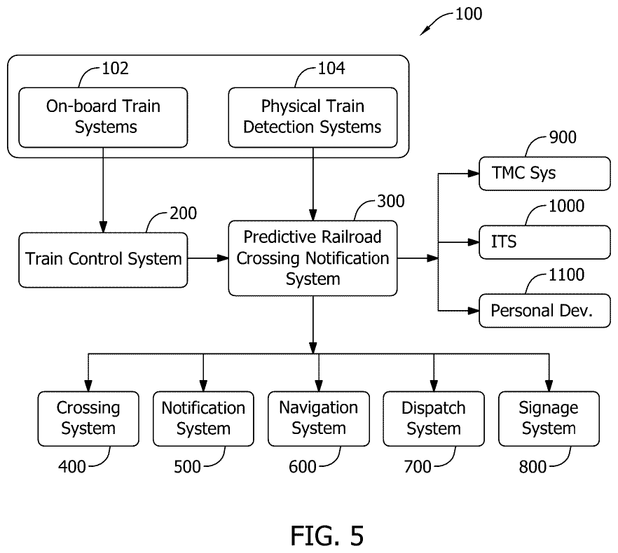

FIG. 4 schematically illustrates an operation of the predictive railroad crossing notification and traffic control system 100, which is also shown in block diagram form in FIG. 5.

As shown, a vehicle 50 is progressing on a roadway 60 toward a railroad crossing 70 where the roadway 60 crosses a set of railroad tracks 80 upon which a locomotive train 90 is progressing toward the crossing 70. The roadway 60 is only one of many roadways that include a railroad crossing 70 with railroad tracks 80 upon which numerous trains 90 can operate at any given time. Numerous trains 90 and numerous vehicles 50 can approach the various different crossings at different locations at about the same time.

In various different examples, the railroad crossing 70 may be public or private, may or may not include a physical train detection system, and may or may not include an active or passive warning system. The predictive estimates generated by the system 100 via the predictive railroad crossing notification system 300 are universally applicable to different types of crossings that are identifiable to the system. Because the system 300 does not require physical train detection at any individual crossing to generate train ETA and blocked crossing duration estimates, the system is capable of improving safety and traffic routing at crossings that are not presently equipped with railroad-operated or third party supplied train detection systems. For crossings that are presently supplied with railroad-operated or third party train detection systems and active crossing warning systems, additional functionality and improvements is made possible by the system as described herein.

The railroad tracks 80 in the example of FIG. 4 are PTC enabled tracks such that Positive Train Control system 200 operates with full awareness of operating status of the train 90. The onboard system 102 (FIG. 1) of the train locomotive reports train data to the PTC system 200 via, for example, 220 MHZ wireless network or cellular networks to rail edge servers and ultimately to a centralized PTC system 200 and database for storage.

In the illustrated example, the PTC system 200 operating at a predetermined frequency iteratively outputs data to the predictive railroad crossing notification system 300. The interval may be about every ten minutes to provide updated data and information regarding the operation of the train 90 as it progresses toward the crossing 70. In one contemplated embodiment, the data output from the PTC system is a subset of the data collected from the train 90, and as shown in FIG. 4 the output data includes a date/time stamp, train ID (converted to a serialized identifier), train length, train speed, train heading and location data reported by Division, Subdivision, Branch and Milepost. In the illustrated example, the PTC system 200 does not output the GPS coordinates of the train directly, but instead indirectly reports the location along the railroad corridor route by Division, Subdivision, Branch and Milepost.

The predictive railroad crossing notification system 300 receives the output data from the PTC system 200 as a trusted PTC data custodian. The predictive railroad crossing notification system 300 may receive data and data updates from multiple railroad operators concerning the respective trains operated by each railroad entity. The data outputs may be the same or different in format and content from systems operated by each railroad entity. The data outputs from the PTC system 200 are input to the predictive railroad crossing notification system 300, and the system 300 determines train ETA and blocked crossing duration estimates at the crossings that each train is moving toward. As described above, the estimate generation may involve consultation of the database 326 for crossing identification, route information, and Milepost conversion to determine the distances needed to make the desired estimates. While one database 326 is shown in FIG. 4, more than one database may be needed for complete access to crossing identification, route information, and Milepost conversion tasks. When the predictions are completed, the predictive railroad crossing notification system 300 outputs estimate information in the example shown in a twofold manner with roadway information and crossing information.

The roadway information data is output with date/time stamp, cross street data, and GPS coordinate data in one example. The crossing information is output in terms of crossing activation time with train ETA at an identified crossing and estimated duration of the blocked crossing by the train. The GPS coordinates in the roadway information may be the GPS coordinates of the crossing, serving the dual purpose of driver/vehicle notification of an arriving train well in advance of its actual arrival at each crossing, as well as providing notification and operating warning systems at the crossing itself. The data outputs from the predictive railroad crossing notification system 300 may be communicated wirelessly and may be received by numerous vehicle systems and numerous crossing locations at each update interval by the PTC system 200. In some cases, wired communication from the predictive railroad crossing notification system 300 to external devices may also be made. Any secure communication protocol may be utilized to communicate the output estimate information from the predictive railroad crossing notification system 300.

In the examples shown in FIGS. 4 and 5, the predictive railroad crossing notification system 300 proactively communicates train ETA and blocked crossing duration estimate data to crossing systems 400 operative at the location of each crossing, notification devices and systems 500 that are not at the crossing, vehicle navigation systems 600 that can intelligently inform motorists and assist with alternative route options to avoid a crossing if desired, vehicle dispatch systems 700 such as emergency vehicle dispatch centers, and vehicle route signage systems 800 located along the roadway at some distance from the crossings with active train ETA and blocked crossing duration estimate data for a train on approach. Each of the systems 400, 500, 600, 700 and 800 are further described below.

As shown in FIG. 5, still further estimate information data outputs are communicated from the predictive railroad crossing notification system 300, including but not necessarily limited to a Traffic Message Channel (TMC) system 900 that communicates traffic information via FM radio broadcasts for the benefit of motorists, an Intelligent Transportation System (ITS) system 1000, and to personal devices 1100 such as smartphones. Communications received through personal devices 1100 allows estimate information to be received apart from any vehicle operation when desired. While not shown in FIG. 5, train ETA and blocked crossing duration estimates could also be proactively communicated to Transportation Management Systems for commercial business operations to more effectively manage fleet vehicles and improve efficiencies.

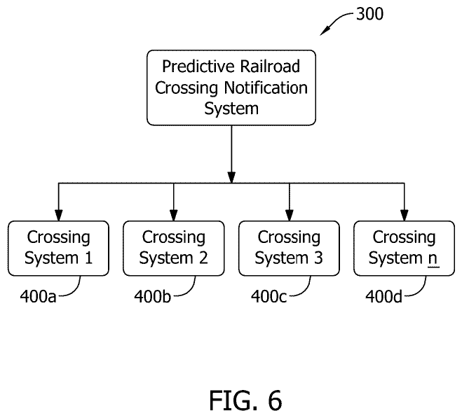

FIG. 6 is a block diagram of a first exemplary subsystem of the exemplary predictive railroad crossing notification and traffic control system 100 making clear that the predictive railroad crossing notification system 300 is scalable to communicate with any number n of crossing systems 400a, 400b, 400c, and 400d. The crossing systems 400a, 400b, 400c and 400d are located at different locations along the same or different railroad corridors of the same or different railroad entity.

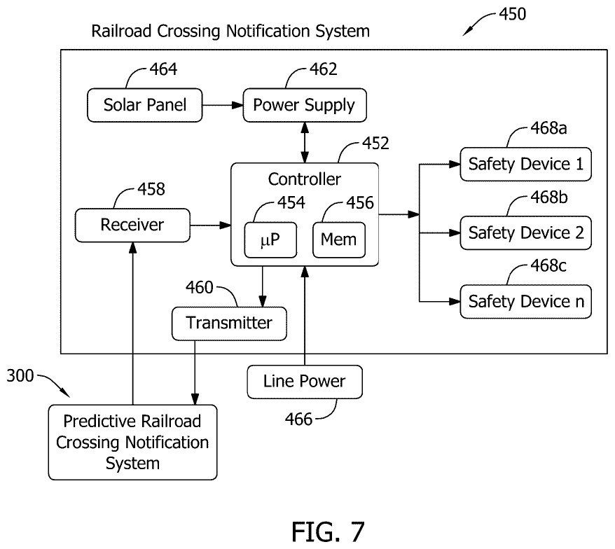

An exemplary crossing notification system 450 is shown in FIG. 7 as one example of a crossing warning system 400 for the system 100. The system 450 includes a controller 452 having a microprocessor 454 and a memory 456. The system 450 further includes a receiver 458 and a transmitter 460 for receiving and sending wireless data and information signals from and to the predictive railroad crossing notification system 300. In some embodiments, the receiver 458 and transmitter 460 could effectively be combined into one element known as a transceiver. In another embodiment wherein hard wired communication is employed, the receiver 458 and transmitter 460 may be considered optional and need not be included, and other communication interfaces may be appropriately included in the system 450.

In one embodiment, the controller 452 and other elements in the system 450 are powered by an onboard power supply 462 such as a battery, which may in turn be renewably charged by one or more photovoltaic solar panels 464. As such, the system 450 can be beneficially installed and used at relatively low cost in remote, rural areas where hard wired electrical cabling does not exist. Additionally, the solar powered system could be easily installed at a low cost point in locations where hard wired cabling does exist. Alternatively, and as also shown in FIG. 7, the controller 452 may be connected to a line power supply 466 where such line supply exists at a crossing site, or is affordably provided.

The controller 452 is responsive to the data outputs of the predictive railroad crossing notification system 300 to operate safety devices 468a, 468b, 468c at the site of the crossing where the system 450 is installed when the generated crossing estimates apply to the crossing. The safety devices may include in different embodiments, static (i.e., constant) or dynamic (i.e., flashing) warning lights, audio alert devices, and/or the operation of barrier/gate devices. Functionality of existing crossing warning systems may be provided by systems 450 when desired at crossings that do not presently include a train detection system or active or passive warning system. The number of safety devices is scalable to communicate with any number n of the aforementioned safety devices or other safety devices appropriately employed to improve crossing safety. In some cases, more than one system 450 may be installed at the same crossing.

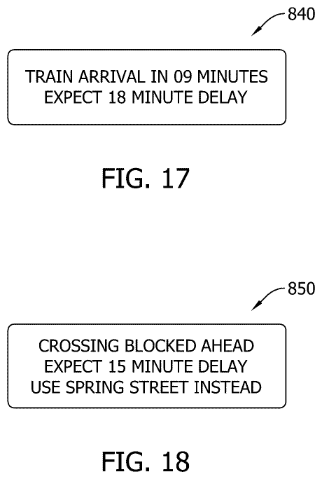

In some embodiments, the safety devices 468 may include electronic signage notifying drivers of train ETA and blockage duration at the crossing site. For instance, the signage may display the message “TRAIN ARRIVAL IN 09 MINUTES” and “EXPECT 18 MINUTE DELAY” as illustrated in FIG. 17. Such signage could also be provided along a roadway in advance of the crossing site as further described below, perhaps with additional information identifying the crossing and optionally including a suggested detour. Drivers would therefore be afforded information that is not presently available to facilitate more optimal decisions. Drivers who wish to avoid an 18 minute delay in this example would have up to nine minutes to select an alternative route that would avoid traffic idling for an extended period of time. Of course, any motorist that chooses an alternative route would mean one less vehicle at the crossing site when the train actually arrives, and safety concerns would be reduced. Vehicles that are not present upon train arrival cannot collide with the train.

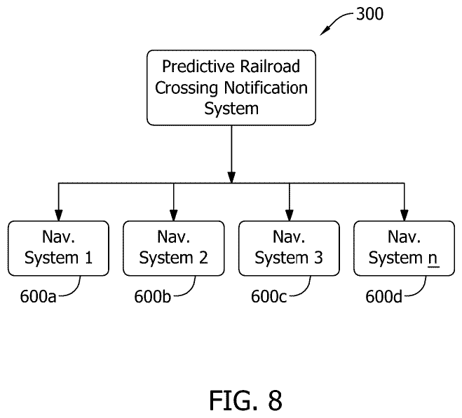

FIG. 8 is a block diagram of a second exemplary subsystem of the exemplary predictive railroad crossing notification and traffic control system 100 making clear that the predictive railroad crossing notification system 300 is scalable to communicate with any number n of navigation systems 600a, 600b, 600c, and 600d. The navigation systems 600a, 600b, 600c, and 600d may be web-enabled systems connecting to vehicle systems or user devices such as smartphones, or built-in systems of vehicles accessible through OEM infotainment systems, or dedicated add-on navigational devices for vehicles that do not include OEM navigation systems. The predictive railroad crossing notification system 300 may communicate with the navigation systems 600a, 600b, 600c, and 600d in native formats for the respective systems to simplify actions to be taken by the navigation systems 600a, 600b, 600c, and 600d to avoid crossing delays when desired.

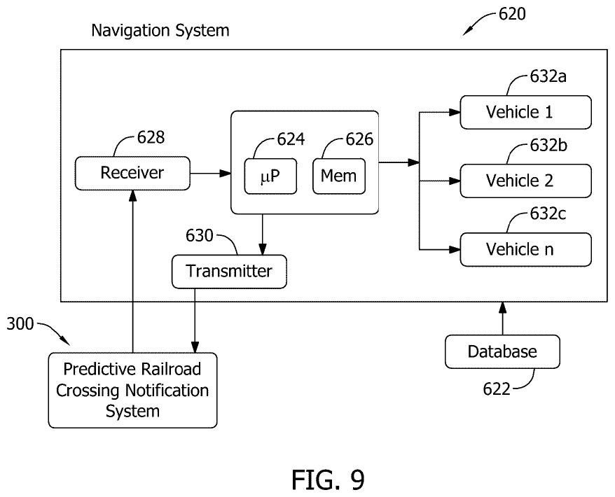

A first exemplary navigation system 620 is shown in FIG. 9 as a centralized navigation system 600 for the system 100. The system 620 includes one or more databases, a microprocessor 624 and a memory 626. The system 620 further includes a receiver 628 and a transmitter 630 for receiving and sending wireless data and information signals from and to the predictive railroad crossing notification system 300. In some embodiments, the receiver 628 and transmitter 630 could effectively be combined into one element known as a transceiver. In another embodiment wherein hard wired communication is employed, the receiver 628 and transmitter 630 may be considered optional and need not be included, and other communication interfaces may be appropriately included in the system 620.

The system 620 may be configured as a server-based localized navigation system information distributor application system. The system 620 is responsive to estimates generated by the predictive railroad crossing system to wirelessly communicate information to devices 632a, 632b, 632c or to provide the devices 632a, 632b, 632c access to the desired data. The devices 632a, 632b, 632c may be present in various different vehicles or to connected vehicles through devices such as smartphones. The system 620 is scalable to communicate with or provide service to any number n of devices 632.

In one contemplated example, the system 620 is a community-driven GPS navigation map which utilizes aggregated real-time data from the app's users to provide the best route to the user's destination. One popular system of this type corresponds to the popular Waze app available to iPhone and Android users. A system of this type beneficially may receive and send proactive train ETA and blocked crossing duration information to users who may respond with route changes that will be made available to other users on the system. As such, drivers may as a group avoid an 18 minute delay at a blocked crossing per the example above.

Alternatively the system 620 may be a data centric system operable on demand by system users of apps or subscription services. Apple Maps, Google maps and Sirius navigation systems are popular systems of this type. The system 620 of this type may be responsive to train ETA and blocked crossing duration information to users as routes are requested by users or may issue notifications to users in route. For example, if the above example of an 18 minute delay applies (or is about to apply) at a crossing along a possible route at the time that a route request is made, the system 620 could automatically suggest another route, or at least notify the user that a delay will be incurred for an available route option. As such, the user has opportunity before setting off to choose another route, delay start time, or take another action to avoid the lengthy delay.

Similar considerations apply to routes in progress. For example, a motorist may have been travelling for some time along a chosen route but may opt for a change when notified that an 18 minute delay may be incurred on the route ahead. Based on system preferences, the vehicle may be re-routed automatically by the system, the driver may be prompted for an alternative route selection, or the driver may be simply notified without the system providing an alternative route option.

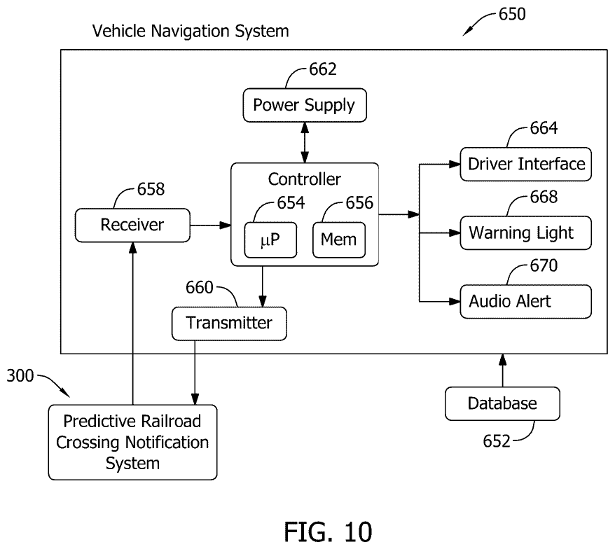

A second exemplary navigation system is shown in FIG. 10 as a vehicle-based navigation system 650 for the system 100. The system 650 is an onboard vehicle system including a database 652 with route information, a microprocessor 654 and a memory 656. The system 650 further includes a receiver 658 and a transmitter 660 for receiving and sending wireless data and information signals from and to the predictive railroad crossing notification system 300. In some embodiments, the receiver 658 and transmitter 660 could effectively be combined into one element known as a transceiver.

The system 650 may be configured as OEM equipment that is built-in to the vehicle system, or as an aftermarket, add-on system to provide navigational functionality for the vehicle. As such, in the case of OEM equipment the system 650 may be powered by the vehicle power system power supply battery 662. In the case of an aftermarket system, the system could have a separate power supply such as a rechargeable battery power supply 662 that is connectable to the vehicle power system when needed.

The system 650 is responsive to estimates generated by the predictive railroad crossing system to wirelessly communicate information to a driver interface 664 such as any number of known infotainment device display screens and input selectors or separately supplied, dashboard or windshield mounted display screens. One or more warning lights 668 may also be activated in the vehicle to garner the attention of a driver, and one or more audio alert devices 670 may be activated. Based on train ETA and blocked crossing estimates the system 650 may automatically redirect the driver to another route, prompt the driver to elect an alternative route, or simply inform the driver for use in making a personal choice how the driver would like to proceed. As such, the driver may take action to avoid the 18 minute delay at a blocked crossing per the example above.

On certain trips, the systems 620 and 650 may operate more than once to provide opportunity for a driver to avoid delays at more than one railroad crossing. Significant reduction in driving time may result by avoiding stalled traffic at crossings for lengthy period of time, as well as a more pleasant commute for drivers. Additionally, the estimates provided by the predictive railroad crossing notification system can in some cases be activated even when the navigation system is otherwise not being used. That is, the estimates can be applied for crossings in the immediate area to inform drivers who may or may not intend to proceed along the crossing.

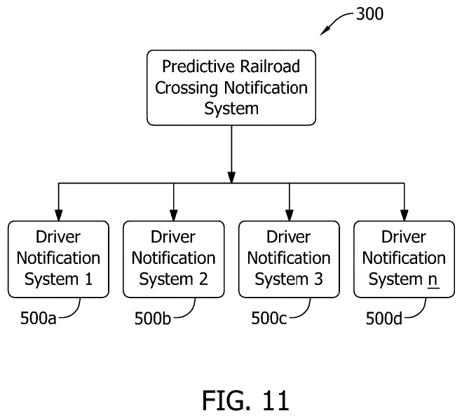

FIG. 11 is a block diagram of a third exemplary subsystem of the exemplary predictive railroad crossing notification and traffic control system 100 making clear that the predictive railroad crossing notification system 300 is scalable to communicate with any number n of driver notification systems 500a, 500b, 500c, and 500d.

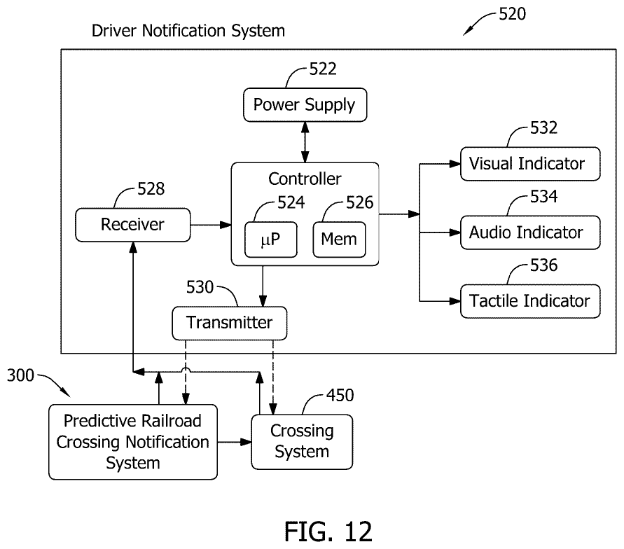

A first example of a driver notification system 520 is shown in FIG. 12 that may be advantageously used in the system 100. The system 520 includes onboard power supply 524 such as a battery, a microprocessor 524 and a memory 526. The system 520 further includes a receiver 528 and a transmitter 530 for receiving and sending wireless data and information signals from and to the predictive railroad crossing notification system 300. In some embodiments, the receiver 528 and transmitter 530 could effectively be combined into one element known as a transceiver.

The controller including the microprocessor 524 is responsive to the data outputs of the predictive railroad crossing notification system 300 or to a communication from a crossing system 450 that has been supplied the data outputs of the predictive railroad crossing notification system 330. In response to the data outputs received, the controller operates one or more notification devices in the form of a visual indicator 532, an audio indicator 534, or a tactile indicator 536 in the example shown.

In one embodiment the system 520 is configured as a dedicated receiver device that can be located in a vehicle to receive crossing proximity alerts when the receiver device comes within a predetermined range of the crossing system 450 that broadcasts signals to the receiver device. When the receiver device in the vehicle is within signal range of the crossing system, the receiver device actives the visual indicator 532 (e.g., a warning light) as visual warning, the audio indicator 534 (e.g., chime, beep or voice message), and/or the tactile device 536 (e.g., a vibrating element) to call the driver's attention to a crossing ahead based on the applicable predictive train ETA and blocked crossing duration estimate for the roadway ahead.

As such, the system 520 effectively provides a special purpose, active warning system inside a vehicle as crossings are approached at times coincident with an arriving train. The system 520 may, for example, be mounted on a vehicle dashboard or windshield, or integrated into a rearview mirror assembly in various non-limiting examples. The system may include display features (e.g., a display screen or heads up projection on the windshield in front of the driver) to present graphical information such as railroad crossing systems and messages to a driver including train ETA and blocked crossing estimate information for a crossing that the vehicle is approaching. In other cases, the system 520 may be implemented as a relatively low cost, simple transponder device that operates on short range radio communications or other lower power communication protocols such as Bluetooth to provide basic driver notifications in a low cost manner.

The disclosure of U.S. Pat. No. 9,193,367 of Island Radar, hereby incorporated by reference in its entirety, teaches a crossing proximity and train-on-approach notification system using low power, short range radio communication which may benefit from the predictive estimates of the present invention and may therefore be combined with or incorporated by the system 100 in further embodiments. The system of U.S. Pat. No. 9,193,367 teaches train communication with crossing devices and train detection systems at the crossing to trigger train-on-approach notifications that could be compared with train ETA estimates and blocked crossing duration estimates to assess accuracy of the predictive estimates and intelligently adjust estimates over time based on such additional data points.

Devices 520 may also be carried by persons apart from a vehicle to receive predictive train ETA estimates and blocked crossing duration estimates. That is, the devices 520 could be used to actively warn persons who are not operating a vehicle or a train in the area. As non-limiting examples, such estimate information provided by the system of the invention would be advantageously known and utilized by railroad workers performing tasks at crossing sites, certain pedestrians who need to cross railroad tracks to and from destinations, and persons enjoying recreational activities such as biking or hiking in areas including railroad corridors. Decision making to ensure safety and avoid inconvenience by such persons is made possible via advance notice and additional lead time that the predictive estimates of train activity provide.

In another embodiment the system 520 is configured as a multipurpose device that can be used with and without a vehicle to receive person crossing proximity alerts when the receiver device comes within a predetermined range of the crossing system 450 that broadcasts signals to the receiver device. For example, the system 520 may be configured as a smartphone device running an app that selectively communicates with crossing systems 450 that are in signal range.

In still another embodiment, the system 520 may be configured as a smartphone device running an app that selectively communicates with the predictive railroad crossing notification system 300 to receive updated estimate information from the system 300 over time. The smartphone owner could use the app while driving, biking, walking, working at a crossing site, or in other activity wherein advanced knowledge of train activity would be beneficial for safety reasons and to avoid disruptions in travel plans.

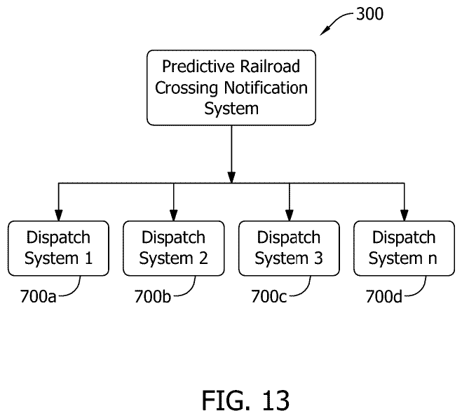

FIG. 13 is a block diagram of a fourth exemplary subsystem of the exemplary predictive railroad crossing notification and traffic control system 100 making clear that the predictive railroad crossing notification system 300 is scalable to communicate with any number n of vehicle dispatch systems 700a, 700b, 700c, and 700d.

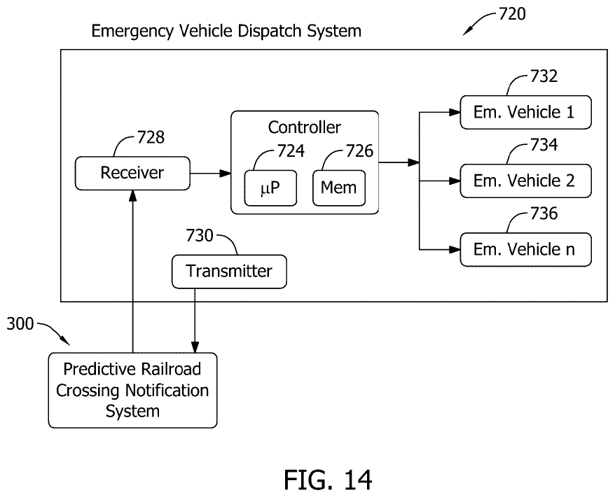

A first example of a vehicle dispatch system 720 is shown in FIG. 14 that may be advantageously used in the system 100. The system 720 includes a microprocessor 724 and a memory 726. The system 720 further includes a receiver 728 and a transmitter 730 for receiving and sending wireless data and information signals from and to the predictive railroad crossing notification system 300. In some embodiments, the receiver 728 and transmitter 730 could effectively be combined into one element known as a transceiver. In another embodiment wherein hard wired communication is employed, the receiver 728 and transmitter 730 may be considered optional and need not be included, and other communication interfaces may be appropriately included in the system 720.

The controller including the microprocessor 724 is responsive to the data outputs of the predictive railroad crossing notification system 300 to notify and/or re-route emergency vehicles 732, 734, 736 in view of the predictive estimate information generated that may negatively impact response time of the emergency vehicles 732, 734, 736 to arrive at respective locations of emergencies to assist and respond. The emergency vehicles may include, without limitation, police vehicles (cars, trucks and motorcycles), ambulances, firetrucks and other vehicles, including personal vehicles of emergency response personnel. Notifications generated by the system 720 may include suggested alternative routes, and may be automatically generated or manually provided by human dispatchers.

The system 720 may serve other vehicles besides emergency vehicles in some desired applications. For example, commercial fleet vehicles and delivery vehicles may realize significant efficiency increases by avoiding crossing-related traffic disruptions when possible. Passenger transportation vehicles such as buses, vans, shuttle vehicles, and taxis may likewise reap significant benefit from proactively ability to select optimal routes or change routes to avoid crossing-related travel delays. Drivers or ridesharing services (e.g., Uber and Lyft) may also be beneficially notified by a system similar to the system 720 in a centralized manner.

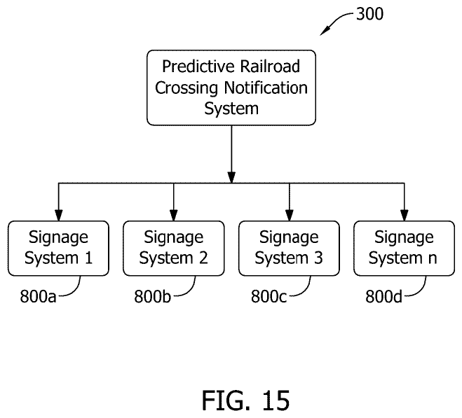

FIG. 15 is a block diagram of a fifth exemplary subsystem of the exemplary predictive railroad crossing notification and traffic control system 100 making clear that the predictive railroad crossing notification system 300 is scalable to communicate with any number n of vehicle route signage systems 800a, 800b, 800c, and 800d.

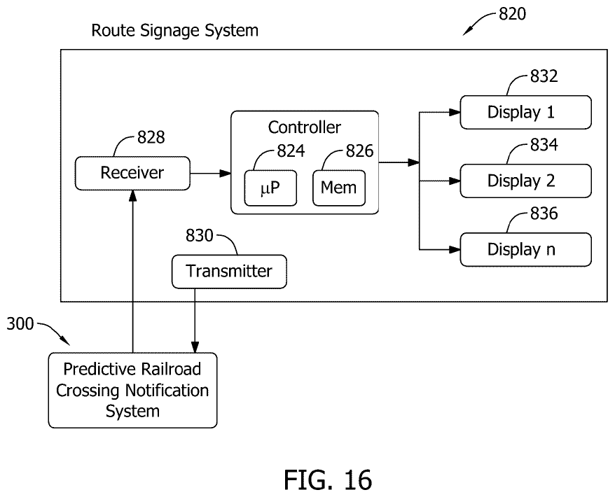

A first example of a vehicle route signage system 820 is shown in FIG. 16 that may be advantageously included in the system 100. The system 820 includes a microprocessor 824 and a memory 826. The system 820 further includes a receiver 828 and a transmitter 830 for receiving and sending wireless data and information signals from and to the predictive railroad crossing notification system 300. In some embodiments, the receiver 828 and transmitter 830 could effectively be combined into one element known as a transceiver. In another embodiment wherein hard wired communication is employed, the receiver 828 and transmitter 830 may be considered optional and need not be included, and other communication interfaces may be appropriately included in the system 820.

The controller including the microprocessor 824 is responsive to the data outputs of the predictive railroad crossing notification system 300 to message route status information to one or more electronic signage including displays 832, 834, 836 in view of the predictive estimate information generated for crossings that vehicles are approaching. The displays may be located at the same or different site on a side of the roadway for observation by drivers. The displays present generated alphanumeric messages to motorists concerning the train ETA and blocked crossing duration estimates. Exemplary electronic signage displays are illustrated in FIGS. 17-21 notifying drivers of train ETA and blockage duration at various different locations.

The exemplary signage display 840 may show the message “TRAIN ARRIVAL IN 09 MINUTES” and “EXPECT 18 MINUTE DELAY” as illustrated in FIG. 17. In contemplated embodiments, this signage display would be appropriately displayed at the applicable crossing site. The message may be displayed in its entirety or in portions that switch back and forth from one to the other. For example, the signage may alternately display portions of the message in sequence such as the signage displaying only “TRAIN ARRIVAL IN 09 MINUTES” followed by only “EXPECT 18 MINUTE DELAY” and back again. Such signage may be utilized at a crossing that does not include one of the crossing systems 400, 450 providing active warning features for the crossing (e.g., lights, sounds and gates) to alert motorists. Likewise, such signage could be utilized at crossings with existing active or passive warning systems of the railroad or a third party to provide additional notification functionality including predicted crossing status information (train arrival information or train ETA) and blocked crossing duration estimate (expected delay) that does not presently exist from the perspective of motorists. The signage display 840 would dynamically count down the arrive time for motorists passing by at different times. For example, one minute later from the example above, the signage display 840 may show the message “TRAIN ARRIVAL IN 08 MINUTES” and “EXPECT 18 MINUTE DELAY”.

At the expiration of the ETA period, the signage display 840 can switch to message “TRAIN AT CROSSING, EXPECT 18 MINUTE DELAY” and then dynamically count down the expected delay for motorists until the expected delay time has expired. The signage display 840 can then turn off until subsequent predictive estimate information is received. Optionally, the signage display 840 can message “CROSSING CLEAR” as an indication that neither a train nor delay is expected at the crossing.

The exemplary signage display 850 may show the message “CROSSING BLOCKED AHEAD”, “EXPECT 15 MINUTE DELAY” and “USE SPRING STREET INSTEAD” as illustrated in FIG. 18. In contemplated embodiments, this signage display would be appropriately displayed at some distance from the crossing site that is the subject of the message. For example, in the case of a municipality, the signage 860 may be located 0.5 mi from the crossing, with Spring St. traversing the roadway between the signage and the crossing. The message may be displayed in its entirety or in smaller portions that switch from one portion to the other in sequence. Such signage provides additional notification functionality including crossing status information (blocked crossing), blocked crossing duration estimate (expected delay) and a suggested alternative route option (e.g., Spring St.) that does not presently exist from the perspective of motorists. The signage display 850 would dynamically count down the arrive time for motorists passing by at different times. For example, one minute later from the example above, the signage display 850 may show the message “CROSSING BLOCKED AHEAD”, “EXPECT 14 MINUTE DELAY” and “USE SPRING STREET INSTEAD”. Additional signage (static or dynamic) may be provided on Spring Street with additional detour route information.

At the expiration of the crossing delay period, the signage display 850 can then turn off until subsequent predictive estimate information is received. Optionally, the signage display 850 can message “CROSSING AHEAD CLEAR” as an indication that neither a train nor delay is expected at the crossing.

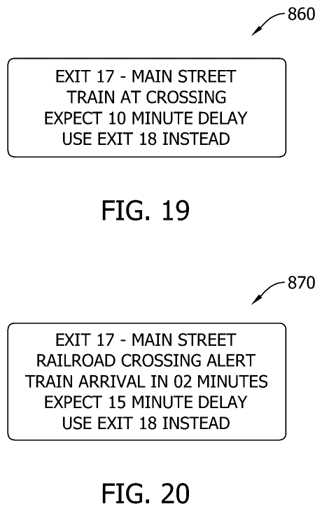

The exemplary signage display 860 may show the message “EXIT 17-MAIN STREET”, “TRAIN AT CROSSING”, “EXPECT 10 MINUTE DELAY”, “USE EXIT 18 INSTEAD” as illustrated in FIG. 19. In contemplated embodiments, this signage display would be appropriately displayed alongside a highway. The message may be displayed in its entirety or in smaller portions that switch from one portion to the other in sequence. Such signage provides additional notification functionality including route information (Exit 17-Main Street) accessible from the highway which includes a crossing, the crossing status (e.g., blocked by the train at the crossing), blocked crossing duration estimate (expected delay) and a suggested alternative route option (e.g., Exit 18) that does not presently exist from the perspective of motorists. The signage display 860 would dynamically count down the delay time for motorists passing by at different times. For example, one minute later from the example above, the signage display 860 may show the message “EXIT 17-MAIN STREET”, “TRAIN AT CROSSING”, “EXPECT 09 MINUTE DELAY”, “USE EXIT 18 INSTEAD”. Additional signage (static or dynamic) may be provided at Exit 18 with additional detour route information.

The exemplary signage display 870 may show the message “EXIT 17—MAIN STREET”, “RAILROAD CROSSING ALERT”, “TRAIN ARRIVAL IN 02 MINUTES”, “EXPECT 15 MINUTE DELAY”, “USE EXIT 18 INSTEAD” as illustrated in FIG. 20. In contemplated embodiments, this signage display would be appropriately displayed alongside a highway. The message may be displayed in its entirety or in smaller portions that switch from one portion to the other in sequence. Such signage provides additional notification functionality including route information (Exit 17-Main Street) accessible from the highway which includes a crossing, train ETA information for the crossing along that route, blocked crossing duration estimate (expected delay) and a suggested alternative route option (e.g., Exit 18) that does not presently exist from the perspective of motorists. The signage display 870 would dynamically count down the arrive time for motorists passing by at different times. For example, one minute later from the example above, the signage display 870 may show the message “EXIT 17—MAIN STREET”, “RAILROAD CROSSING ALERT”, “TRAIN ARRIVAL IN 01 MINUTES”, “EXPECT 15 MINUTE DELAY”, “USE EXIT 18 INSTEAD”. Additional signage (static or dynamic) may be provided at Exit 18 with additional detour route information.

The messages of FIGS. 19 and 20 may be alternately displayed in a dynamic manner by the same signage, in one case to count down the blocked crossing duration and in the other to count down the train ETA. At the expiration of the crossing delay period, the signage display can then turn off until subsequent predictive estimate information is received. Optionally, the signage display can message “EXIT 17—MAIN STREET”, “RAILROAD CROSSING CLEAR” as an indication that neither a train nor delay is expected at the crossing.

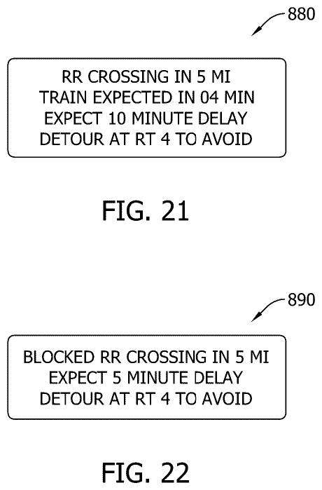

The exemplary signage display 880 may show the message “RR CROSSING IN 5 MI”, “TRAIN EXPECTED IN 04 MIN”, “EXPECT 10 MINUTE DELAY”, “DETOUR AT RT 4 TO AVOID” as illustrated in FIG. 21. In contemplated embodiments, this signage display would be appropriately displayed along a rural route. The message may be displayed in its entirety or in smaller portions that switch from one portion to the other in sequence. Such signage provides additional notification functionality including crossing information for the route (railroad crossing 5 miles ahead), train ETA information for the crossing ahead, blocked crossing duration estimate (expected delay) and a suggested alternative route option (e.g., Route 4) that does not presently exist from the perspective of motorists. The signage display 880 would dynamically count down the arrive time for motorists passing by at different times. For example, one minute later from the example above, the signage display 880 may show the message “RR CROSSING IN 5 MI”, “TRAIN EXPECTED IN 03 MIN”, “EXPECT 10 MINUTE DELAY”, “DETOUR AT RT 4 TO AVOID”. Additional signage (static or dynamic) may be provided along Route 4 with additional detour route information.

The exemplary signage display 890 may show the message “BLOCKED RR CROSSING IN 5 MI”, “EXPECT 5 MINUTE DELAY”, DETOUR AT RT 4 TO AVOID″ as illustrated in FIG. 22. In contemplated embodiments, this signage display would be appropriately displayed along a rural route. Such signage provides additional notification functionality including crossing status information for the route (blocked crossing 5 miles ahead), blocked crossing duration estimate (expected delay) and a suggested alternative route option (e.g., Route 4) that does not presently exist from the perspective of motorists. The signage display 890 would dynamically count down the arrive time for motorists passing by at different times. For example, one minute later from the example above, the signage display 880 may show the message “BLOCKED RR CROSSING IN 5 MI”, “EXPECT 4 MINUTE DELAY”, DETOUR AT RT 4 TO AVOID″. Additional signage (static or dynamic) may be provided along Route 4 with additional detour route information.

The messages of FIGS. 21 and 22 may be alternately displayed in a dynamic manner by the same signage, in one case to count down the train ETA and in the other to count down the blocked crossing duration. At the expiration of the crossing delay period, the signage display can then turn off until subsequent predictive estimate information is received. Optionally, the signage display can message “RR CROSSING IN 5 MI”, “CLEAR-NO TRAIN EXPECTED” as an indication that neither a train nor delay is expected at the crossing.

Via exemplary signage and messaging such as those above, drivers who wish to avoid the associated delays may decide whether to incur the delays or change routes (including but not necessarily limited to the suggested alternative routes or detours), or to take other actions to avoid delay associated with the crossings. Of course, any motorist that chooses an alternative route or takes other action would mean one less vehicle at the crossing site when the train actually arrives, and safety concerns would be reduced. Vehicles that are not present upon train arrival cannot collide with the train, and safety at the crossing is marginally improved by advance notice of the train at the crossing that is sufficient for the driver to avoid being at crossings at the same time as the trains or arriving at the crossings at about the same time.

The alphanumeric messages described above are exemplary only. Messages including other content, other order or sequences of content presented, and messages including images or symbols such as directional arrows, railroad crossbucks, and train images may be used in further messages as non-limiting examples. The messages may be generated in any suitable type of dynamic electronic signage.

Similar messages to those described above may be incorporated in and utilized by the other devices in the systems described above including without limitation to the notification devices 500, vehicle navigation systems 600 and vehicle dispatch systems 700 described above with similar benefits.

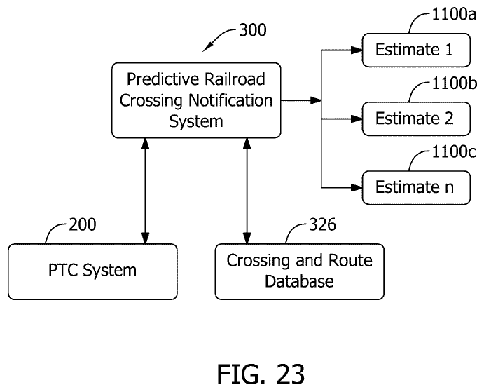

As illustrated schematically in FIG. 23, the predictive railroad crossing system 300 is scalable to provide crossing estimate information outputs for any number n of crossings represented at 1100a, 1100b, 1100c. The estimates 1100a, 1100b, 1100c may be communicated as data inputs to any of the systems and devices described above in a generally simultaneous manner. That is, the system 300 is fully capable of around the clock, real-time operation to iteratively produce estimates at the sampled data frequency for large numbers of crossings associated with large numbers of train operating in different geographic locations, and communicate crossing-specific information to large numbers of crossing systems, vehicle navigation systems, driver notification systems, dispatch systems, traffic messaging channel systems, intelligent transportation systems, transportation management systems, and personal devices as described above.

Collectively, railroad crossing safety improvements and vehicle route enhancement and optimization may be realized by the systems described above in a more or less universally applicable manner across the immense network of roadways and public or private crossings in existence today. Reliable estimates may be generated in more or less real-time resolving the complexities presented in manner that could not be accomplished in the human mind or practically performed with pen and paper due to the intractable problems presented for a manual estimate generation for all operating trains and all identified crossings for the trains that operating simultaneously at different track locations and speeds. Crossing safety and vehicle traffic flow improvements are beneficially realized by the predictive estimates of the systems described for the vast number of crossings that presently have no active or passing warning features and for which conventional train detection systems are not economical.

While an exemplary architecture of systems and subsystems are shown and described, variations are of course possible and may be implemented in further embodiments with otherwise similar functionality. A computer server-based architecture has been shown and described for selected portions of the systems and subsystems, although server-based architectures are not necessarily required for the benefits of the invention to be obtained.

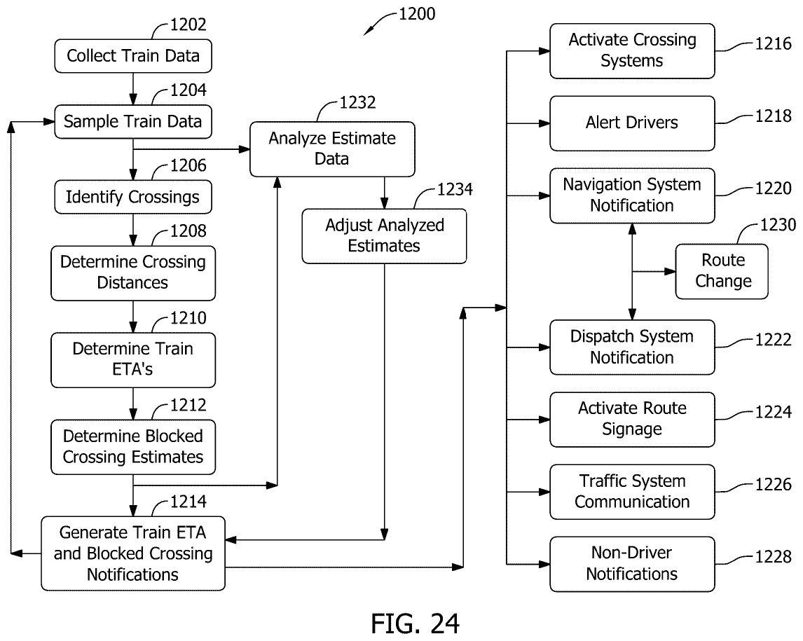

FIG. 24 is an algorithmic flowchart of exemplary methods, processes, and steps performed by the predictive railroad crossing notification and traffic control system 100 of the present invention. The processes 1200 illustrated in FIG. 24 include preliminary steps of providing and connecting the various process-based devices and systems such as those described above (including any enrollment of devices and users as applicable) to implement the predictive train ETA and blocked crossing duration estimates capabilities in order to improve crossing safety and roadway traffic flow to avoid inefficiencies and delay of blocked crossings. The processes 1200 presume that in each device and system of the system 100 the respective controllers, processors and memory storage include executable instructions, commands, and control algorithms to respectively and collectively perform the steps below, as well as, where needed, the controller and processors of each device and system are further placed in communication with a database or other external memory device as appropriate including additional data and information needed to accomplish the functionality described above and below.

The processes 1200 may be implemented as algorithms in the programming or engineering of the respective connected devices shown by example in FIGS. 1-23 above, although variations are possible in further and/or alternative embodiments. The technical effect of the processes and systems described herein is achieved when data and information such as that described above is entered, transmitted, received downloaded or otherwise accepted by or made available to the predictive railroad crossing system 300 via the train control system 200 and the database or databases described in the above examples in order to realize the functionality described herein.

At step 1202 real-time train data is continuously collected for various different numbers n of trains in operation at any given time by the same or different railroad entity on the same or different set of railroad tracks. The real-time train data may be collected by onboard systems of each locomotive, by physical train detection systems operative by railroad entities or third parties operative on specific portions or sections of railroad tracks (typically at and around the site of selected railroad crossings), or both as described above in relation to FIGS. 1-5 in exemplary system embodiments. In contemplated embodiments, the real-time train data is continuously collected principally by the PTC system described above, although the PTC system is not necessarily required in all embodiments to collect sufficient data for purposes of step 1202.

The real-time train data collected at step 1202 includes at least train location data, train speed data, train heading data (i.e., direction of travel data) and train length data for each respective train that is operating. Also, and as described above, the train location data is not simply and directly reported with GPS coordinates but is instead collected by Division, Subdivision, Branch and Milepost of the respective railroad corridor that each respective train is traveling upon. Variations of train data collected are, however, possible in other embodiments dependent on railroad entity willingness to supply data. As explained above, railroad operators are presently reluctant to disclose direct GPS location data for each operating train out of concern that it could be exploited by malicious persons. To the extent that railroad operators may permit it to be utilized for purposes of the systems and methods described herein, or to the extent that train GPS location data can be generated from other systems (e.g., third party train detection systems or roadway vehicle based GPS systems with user reporting features of a trains at crossings) such GPS location data may be collected for purposes of step 1202.

At step 1204, the collected data at step 1202 is sampled at a periodic time interval t which for example may be set to ten minutes. As such, every ten minutes a new data set is considered from the real-time train collection including fresh data regarding train location data, train speed data, train heading data (i.e., direction of travel data) and train length data. Elapsed time data is therefore made available for iterative performance of the steps described below. In the example systems described above, the collected data at step 1202 is output by the train control system and input to the predictive railroad crossing notification system 300 as a trusted broker of otherwise proprietary railroad data. Any mode of data communication is possible between the interfaced predictive railroad crossing notification system 300 and the train control system 200. In some cases the collected data at step 1202 may be retrieved by the predictive railroad crossing notification system 300. Other periodic time intervals t may be selected in various different embodiments. While a range of two to ten minutes is disclosed above, time intervals t of less than two minutes or greater than ten minutes are possible in various different embodiments.

At step 1206, crossings are identified that each operating train is approaching from the heading information in the sampled data that indicates crossings ahead of each train on the routes in which they are operating. The number of crossings identified may be limited as described above and the identified crossings may be public or private crossings. Identified crossings may be determined by the predictive railroad crossing notification system 300 in the manner described above referencing an external crossing database. Variations are, however, possible in other embodiments, and crossings may be identified in other ways. Any number n of crossings may identified, and since the operating trains are moving about in real-time the number n of crossings identified may change considerably at each sampled time interval.

At step 1208, a distance for each operating train location to the identified crossings is determined on a train-by-train and crossing-by-crossing basis. Exemplary determinations of distances to the crossings are described above, including accounting for Milepost to GPS coordinate data and routing information obtained from a separate database per the examples described. In the above-described examples the distances are determined by one or more centralized predictive railroad crossing notification systems 300 in a specific manner, although variations are possible. The distances are simultaneously determined at step 1208 on a train-by-train and crossing-by-crossing basis for the n number of trains operating and the n number of crossings identified at step 1206.

At step 1210, train ETA's are determined or generated based on the crossing distances determined at step 1210 and the known train speed from the data sampled at step 1204. Examples of train ETA determinations are described above, which are performed by the predictive railroad crossing notification system(s) 300 in contemplated examples. Train ETA's are simultaneously generated at step 1210 on a train-by-train and crossing-by-crossing basis for the n number of trains operating and the n number of crossings identified at step 1206.

At step 1212, blocked crossing duration estimates are determined or generated based on the known and the known train length and train speed from the data sampled at step 1204. Examples of blocked crossing duration estimates are described above, which are performed by the predictive railroad crossing notification system(s) 300 in contemplated examples. Blocked crossing duration estimates are simultaneously generated at step 1212 on a train-by-train and crossing-by-crossing basis for the n number of trains operating and the n number of crossings identified at step 1206.

The estimates generated and determined at steps 1210 and 1212 may be correlated with the time of the last data sampled per some of the above-described examples to obtain specific time estimates for the associated events at each crossing. For example, non-specific estimate information for a crossing may be train ETA of 9 minutes, expected delay of 18 minutes, while specific information for the same crossing may be train ETA 1:19 pm with blocked crossing until 1:37 pm. Specific and non-specific time estimates may be generated for different crossings as appropriate depending on the particulars of the identified crossings.

At step 1214, train ETA and blocked crossing notifications are generated. In the examples above, the notifications are generated as outputs of the predictive railroad crossing notification system(s) 300. The notifications generated are made on a crossing-by-crossing basis for the n number of trains operating and the n number of crossings identified at step 1206 and evaluated at steps 1208, 1212 and 1214. The notifications may be made provided in wireless and non-wireless modes as appropriate with crossing identifiers such that receiving devices may respond in kind. Specific communications could be made to different receiving devices and systems using different communication protocols and interfaces.

Once the estimates are generated at step 1214 the predictive railroad crossing notification system(s) 300 in the above examples returns to step 1204 and awaits the next sampled data interval. Based on the refreshed or update data at the next time interval steps 1206 through 1214 are again performed. Iterative estimates are generated in contemplated examples by the predictive railroading crossing notification system(s) 300, with estimate data stored by the predictive railroad crossing notification system(s) 300 at each iteration.

Estimates generated at step 1214 at each iteration are received by systems and devices external to the centralized predictive railroad crossing notification system(s) 300 to realize significant benefits that were not heretofore possible via actions taken and decisions that are enabled by the receiving devices and systems in the following steps.

At step 1216, crossing systems at the respective identified crossings may be activated that are responsive to the estimates generated at step 1214. Active warning system capability may be realized at crossings that may be retrofitted with low cost crossing systems such as those described above in relation to FIGS. 6 and 7 where railroad operating train detection or active warning systems have not been installed and where existing third party train detection systems are not economically provided such as remote crossing locations where commercial power supply cabling does not exist. Additional functionality may also be realized at crossings with existing active warning systems but that lack any predictive capability that the systems and methods of the invention enables. As described above, solar powered crossing systems may be beneficially used, and signage local to the crossing may be utilized that communicate train ETA and blocked crossing estimate information to drivers and persons at the crossing site, optionally with suggested route and detour information as well to avoid travel delays.

At step 1218, driver alerts are generated to notify drivers of pertinent predictive crossing estimate information as the identified crossings are approached. Examples of driver notification devices that are responsive to the pertinent predictive crossing estimates generated at step 1214 are described above as non-limiting examples.

At step 1220, navigation system notifications are generated to notify users of pertinent crossing estimate information in the selection of a route or as the identified crossings are approached. Examples of navigation systems and devices that may be responsive to the pertinent predictive crossing estimates generated at step 1214 are described above as non-limiting examples. In some cases, hardware-enabled alert systems can be provided in tandem with the receiving devices which receive data transmissions and security codes from the trusted broker system 300 in the system examples above to access and decrypt targeted messages to each receiving device for response to generated train ETA estimate and blocked crossing duration estimate information.

At step 1222, vehicle dispatch system notifications are generated as input pertinent crossing estimate information in the selection of a route or as the identified crossings are approached by dispatched vehicles. Examples of vehicle dispatch systems and devices that may be responsive to the pertinent predictive crossing estimates generated at step 1214 are described above as non-limiting examples.

At step 1224, roadway signage is activated in response to the pertinent predictive crossing estimates generated at step 1214. Electronic signage with detailed and dynamic messaging capability are described above as non-limiting examples, some of which include alternative route information or detour information to avoid travel delays.

At step 1226, traffic communication system actions are taken in response to the pertinent predictive crossing estimates generated at step 1214. For example, TMC and ITS systems, among other possibilities may further broadcast crossing status and estimate information for the benefit of the greater motoring public.

At step 1228, non-driver notifications may be made to personal devices of passengers in vehicles, workers at crossing sites, pedestrians, etc. that are not driving a vehicle but may take desired actions in response to the notifications made possible via the pertinent predictive crossing estimates generated at step 1214. In various different embodiments the personal devices may be portable electronic devices such as smartphones, smart watches, tablet devices and laptop or notebook computer devices as non-limiting examples. As such, a user via a personal device could, for example, check and verify in advance that a crossing along a route that he/she intends to traverse is not going to be blocked. A person, who may be a non-driver for the route of interest, may receive verification from the system that the route will be clear, but in a manner that does not require mapping the travel into a navigational aid system.

The notifications and actions associated with steps 1216, 1218, 1220, 1222, 1224, 1226 and 1228 may be made simultaneously to a host of crossing systems, drivers, vehicles with operating navigation systems, dispatch systems, route signage, traffic communication systems and personal non-driver devices. Comprehensive redundancy is provided for broad dissemination of predictive crossing status to large segments of the interested population in different ways to facilitate proactive decision making to avoid blocked crossings with significant benefit to the public at large. In some cases, and as illustrated at step 1230, route changes may be automatically undertaken by certain devices and systems as shown in non-limiting examples by navigation systems and dispatch systems, with or without transparency to drivers or users regarding why specific routing decisions or rerouting have been made.

As illustrated at steps 1232 and 1234, the pertinent train ETAs and blocked crossing estimates are optionally analyzed via comparison to earlier estimate data and physical sensor data that facilitates information feedback to assess the performance and accuracy of the predictive crossing status and estimate information generated. Patterns can be identified in the data over time which may provide a basis to make adjustments in the predicted data values such that the predictive estimates can become more accurate over time and in some cases the predictive estimates may converge with real-world physical train detection events at identified crossings. Machine learning and artificial intelligence may inform the analysis and adjustments at steps 1232 and 1234 to minimize error in predicated estimates generally and to reported estimates specifically for the notifications generated at step 1214.

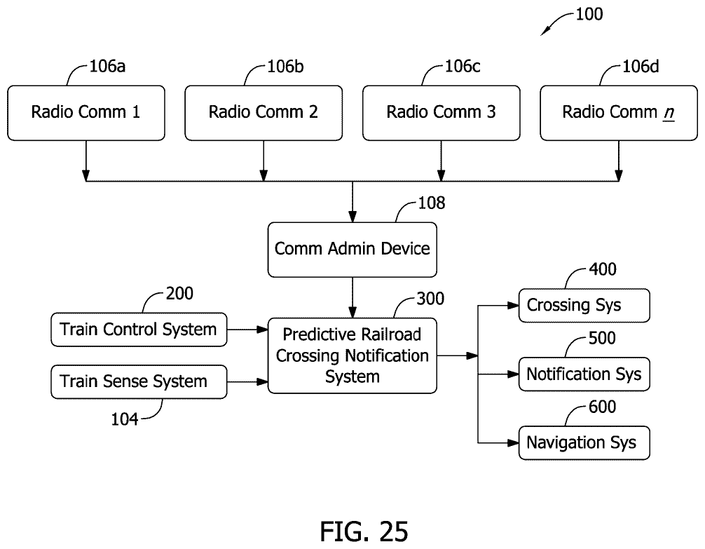

FIG. 25 is a block diagram of another exemplary embodiment of an intelligent processor-based predictive railroad crossing notification and traffic control system 100 of the present invention that, unlike the systems shown in FIGS. 1 and 2, includes another data source for predictively generating train ETA estimates or blocked crossing duration estimates. Specifically, the system 100 of FIG. 25 includes a plurality of data radio devices 106a, 106b, 106c and 106d which may, for example, wirelessly communicate train control system data (e.g., PTC or other train detection system data) in a bidirectional manner to and from a centralized communications administrative computing device 108. The administrative computing device 108 is configured to perform administrative and network management functions for the data radios 106a, 106b, 106c and 106d in a known manner, which in turn may provide some or all of the data needed by the predictive railroad crossing notification system 300 to generate train ETA estimates or blocked crossing duration estimates in a similar manner to that described above for the systems 100 and 200.

In contemplated embodiments, the data radio devices 106a, 106b, 106c and 106d may be distributed along a railroad corridor at different locations, such as at designated base stations of the railroad communication system, at wayside points along railroad corridors to relay data and information to or from the base stations, in locomotives themselves, and at or near highway-rail grade crossings. Effective network management of wireless networks for the radio devices 106a, 106b, 106c and 106d includes administrative functions for monitoring, managing, and optimizing wireless networks, and to perform necessary over-the-air (OTA) software updates coordinated through the administrative computing device 108.

In many cases, one or more of the radio devices 106a, 106b, 106c and 106d in the communications network have, or have access to, GPS data to query information such as the respective radio location, altitude, and velocity. For radio devices 106 which are onboard a locomotive or elsewhere on a train, the GPS data and velocity data of the radios will correspond to the GPS data and velocity data of the locomotive. As such, the administrative management of the network of radios 106 beneficially generates location data and velocity data in a manner independent from any of the onboard sensors of the locomotive that detect and report data to the train control system 200. Such administrative radio data is transmitted amongst the radios separate and apart from the train sensor data that is also communicated amongst the radios.

Advantageously, the train location data and velocity data can be directly known and accessed through administrative radio channels in the networked radio devices which are accessible from the administrative computing device 108, potentially obviating any need to access and employ the train location data and velocity data from the sensor data generated in train control system 200. Therefore, and in contemplated embodiments, the administrative data and information from the radio devices 106 can be desirably used as an alternate, stand-alone source of locomotive location and movement data for the predictive railroad crossing notification system 300 to generate the desired estimates. The data and information from the radio devices 106a, 106b, 106c and 106d may in some embodiments, however, be used in addition to and in combination with corresponding data and information from the train control system 200 and the train sensing system 104 to make the desired predictive estimates of train arrival at a crossing.

Regarding blocked crossing duration estimates for crossings, train length data (i.e., total length of locomotive and any coupled railroad cars) is not available from administrative functions of the radio devices 106a, 106b, 106c and 106d. Generally speaking, prior to a train being dispatched, length information for the train (sometimes referred to as a “consist” in the railroad field) is known and accessible. As such, the length data may be retrieved by the system and utilized in combination with the train location data and velocity data from the radio devices to generate the blocked crossing duration estimates. Train length usually does not change while the locomotive is on its route, but if it does it may be reflected in the train system data and the train length may be accepted from the train control data and used with the location and velocity data of the radios 106 to make the blocked crossing estimates. Comparisons of train length data from different data sources may be made by the system and taken into account when generating blocked crossing duration estimates.

Also advantageously, data from the train control system 200 and data from the radios 106 may also be compared to identify errors in the system. For example, if a radio on the train reports a velocity or position that is different from the velocity sensor(s) or position sensor(s) onboard the train, a notification can be sent to responsible persons to resolve the data inconsistency and take any actions needed to ensure optimal operation of the radio network and reliable train data for purposes of the train control system 200.

Train location data and velocity data from the radio devices 106a, 106b, 106c and 106d can be periodically communicated to the administrative computing device 108 through the radio network, and in turn, to the predictive railroad crossing notification system 300. The additional radio data provides a further basis to evaluate the accuracy of predicted train ETA or estimated blocked crossing duration at the crossings, as well as to improve reliability of estimates made over time, in a similar manner to the systems of FIGS. 1 and 2 as described above. The systems 200 and 104 in such embodiments provide data feedback loops to confirm an accuracy of predictive train ETA estimates or predictive blocked crossing duration estimates by the predictive railroad crossing notification system 300 based on the data and information collected by the radio devices 106a, 106b, 106c and 106d and vice versa. Such feedback loops also provide for intelligent machine learning capabilities to adjust predicted train ETA or estimated blocked crossing duration in real-time as real-world conditions change in a similar manner to the examples above in relation to FIGS. 1 and 2 to operate with a desired degree of self-learning or self-adjusting behavior of the system to generate reliable train ETA and blocked crossing duration estimate data. The system 100 is scalable to include any number of radio devices 106a, 106b, 106c and 106d along the same or different railroad corridors, and more than one administrative computing device 108 may be provided to facilitate different networks or radios as desired.

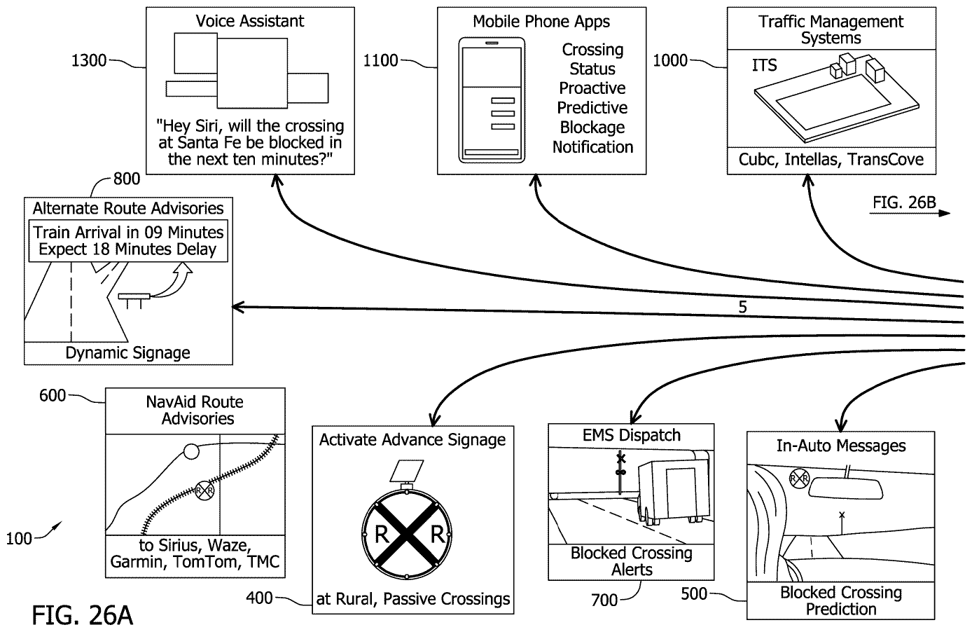

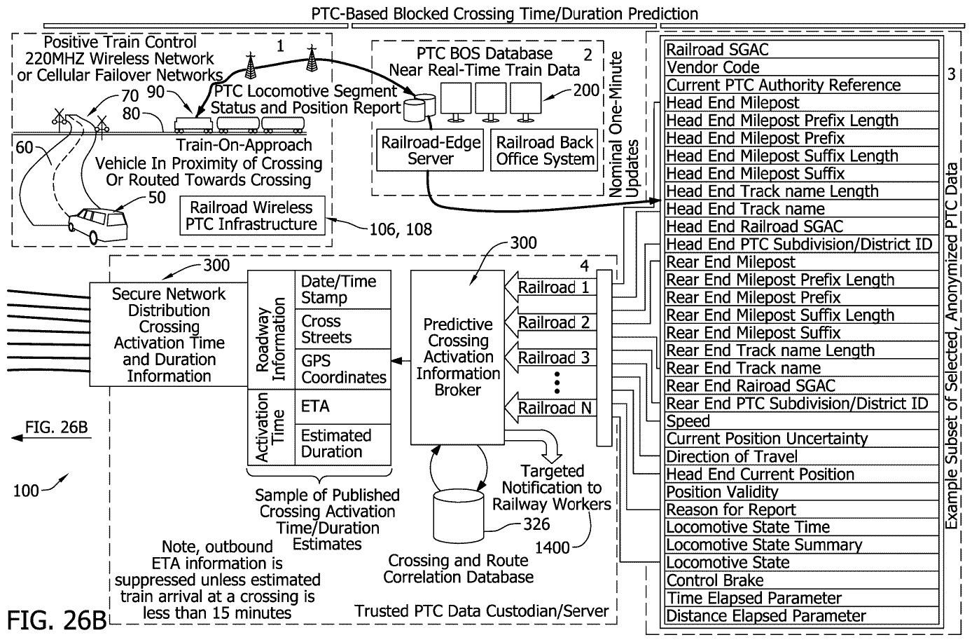

FIGS. 26A and 26B schematically illustrate portions of an operation of the predictive railroad crossing notification and traffic control system 100 shown in FIG. 25. Using any one of the data sources described above, or combinations of the data sources described above, the system operation shown in FIGS. 26A and 26B is similar in many aspects to the operation shown and described above in relation to FIG. 4, and as such like reference characters are utilized to denote like features to those shown in FIG. 4 and the above description of such features shall continue to apply to FIGS. 26A and 26B. The following discussion shall therefore be devoted to further enhancements to the system shown in FIG. 4 for generation of the predictive estimates of train ETA and blocked crossing duration via additional data structures and processing at different iterative intervals, additional notification features and outputs, and different types of notifications with additional processor-based devices.

The radio devices 106 are shown in FIG. 26B as Railroad Wireless PCT Infrastructure. The administrative computing device 108 may also be provided as part of the Railroad Wireless PCT Infrastructure. The administrative computing device 108 may also be operated by an entity other than a railroad operator, such as a radio device provider or supplier responsible for maintaining, optimizing and updating the radio networks over time. The radio network operator may be a type of trusted data broker for the system, although the radio data may not generate the same security concerns as the train control system data as it may not reveal as much sensitive information about the operation of the railroad assets. In other words, the administrative radio data may not include train identifying information and particulars, and therefore may not raise the same concerns of being exploited by bad actors.

A data structure is shown at the left of FIG. 26B which is output from the PCT system as a Locomotive Position Report that is nominally provided at one minute sampling interval as trains are operating. The functional content of each Locomotive Position Report is to include the following with the elements in bold being used to generate predictive train ETA estimates and blocked crossing duration estimates: Railroad Standard Carrier Alpha Code (SCAC), Vendor Code, Current PCT Authority Reference, High End Milepost, High End Milepost Prefix Length, High End Milepost Prefix, High End Milepost Suffix Length, High End Milepost Suffix, Head End Track name Length, Head End Track Name, Head End Railroad SCAC, Head End PTC Subdivision/District ID, Rear End Milepost, Rear End Milepost Prefix Length, Rear End Milepost Prefix, Rear End Milepost Suffix Length, Rear End Milepost Suffix, Rear End Track name Length, Rear End Track name, Rear End Railroad SCAC, Rear End PTC Subdivision/District ID, Speed, Current Position Uncertainty, Direction of Travel, Head End Current Position, Position Validity, Reason for Report, Locomotive State Time, Locomotive State Summary, Locomotive Status, Control Break, Time Elapsed Perimeter, and Distance Elapsed Perimeter. Possible information in the Reason for Report includes encoded information corresponding to events such as a transition from stopped to moving, a transition from moving to stopped, a transition across subdivision/district boundary, a transition from unknown to known track location, and trailing end has passed a signal.

Since the head and rear end location are known from the data structure of 26B, the train length can be determined as the distance between the head and rear end location, taking into account that the mileposts may not be true indicators of track length as discussed in detail above and steps may be taken to accurately determine the track length and corresponding train length for purposes of the predictive blocked crossing duration estimates.

As shown in FIG. 26B, in a contemplated example, the outbound ETA and blockage information of the predictive railroad crossing notification system 300 is suppressed unless the predictively estimated train arrival is within a predetermined window of time such as 15 minutes from the predicted estimate. For example, if the system knows that a predictive ETA for a train is 1:45 pm for a given crossing, it will not output the ETA for that crossing or cause any related notification of estimated train arrival or estimated blockage until 1:30 pm. At times earlier than 1:30 pm (e.g., 1:00 pm) the system may have determined predictive estimates for the crossing but it will not output those estimates until the 1:30 when the 15 minute window prior to arrival of the locomotive (according to the predictive ETA) starts. As such, a nuisance operation of the system from the user perspective in the form of excessive notices or notices too far in advance and which do not require user action at the time they are provided may be avoided. The predetermined window of time may be adjusted to be greater or smaller than 15 minutes to further fine tune operation of the system, and in some embodiments the predetermined window of the time may be an adjustable parameter set by the user to receive notifications with more or less advance notice. In such a case, the outbound estimates may be provided and received by other devices, but notifications may not be presented to the users of those devices until the user selected window of time applies.

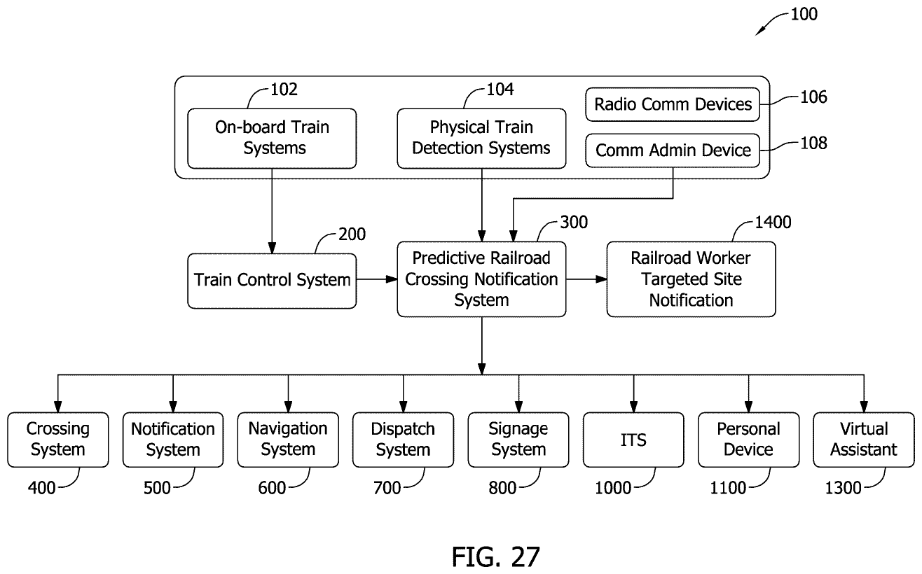

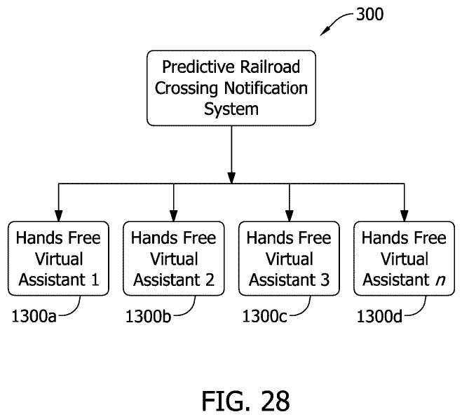

As shown in FIG. 26A and in the block diagram of FIG. 27, the predictive railroad crossing notification system 300 may output the predictive estimates to devices 400, 500, 600, 700, 800, 1000 and 1100 as described above but also to hands free voice-assistant devices 1300 and to railroad worker protection devices 1400 described further below to realize additional functionality and benefits. The algorithmic flowchart of exemplary methods, processes, and steps shown and described above in relation to FIG. 24 generally applies to the systems shown in FIGS. 25-27 and the processor-based devices, with appropriate modification to incorporate the new features and additional processor-based devices introduced in FIGS. 25-27 and further described below in exemplary subsystems and exemplary devices shown in FIGS. 28-39.

FIG. 28 is a block diagram of an exemplary subsystem of the exemplary predictive railroad crossing notification and traffic control system 100 making clear that the predictive railroad crossing notification system 300 is scalable to communicate with any number n of hands free virtual assistant devices 1300a, 1300b, 1300c, and 1300d.

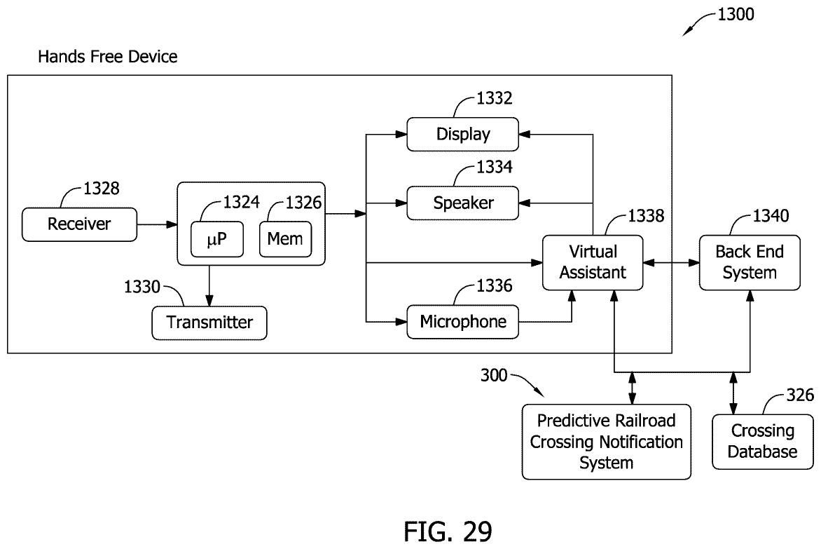

An example of a hands free virtual assistant device 1300 is shown in FIG. 29 that may be advantageously used in the system 100. The device 1300 includes a controller having a microprocessor 1324 and a memory 1326. The device 1300 further includes a receiver 1328 and a transmitter 1330 for receiving and sending wireless data and information signals from and to the predictive railroad crossing notification system 300. In some embodiments, the receiver 1328 and transmitter 1330 could effectively be combined into one element known as a transceiver. In another embodiment wherein hard wired communication is employed, the receiver 1328 and transmitter 1330 may be considered optional and need not be included, and other communication interfaces may be appropriately included in the device 1300.

The device 1300 further includes a display 1332, a speaker 1334 and a microphone 1336. Virtual assistant components 1338 are provided to process and respond to verbal prompts and requests spoken by a person. In contemplated embodiments the virtual assistant components 1338 may be provided as an app running on the device 1300 in a known manner. The virtual assistant components 1338 interact with the crossing database 326 and the predictive railroad crossing notification system 300 as further described below to provide the predictive estimates. The virtual assistant components 1338, in turn, present audible human speech responses on the speaker 1334 and optionally present visual responses on the display 1332. The predictive estimates of train arrival and blocked crossing duration may therefore be presented audially and/or visually for the benefit of vehicle drivers and passengers in a contemplated example. As non-limiting examples, the hands free device 1300 may be configured as a mobile personal computing device such as a smartphone or tablet device that may be carried by a person inside or outside of a vehicle.

A well-known and non-limiting example of a Digital Voice Assistant (“DVA”) that may be implemented though the virtual assistant components 1338 of a mobile computing device is Apple's Siri. Other virtual assistants (e.g., Google Assistant and Amazon Alexa) are known, however, and may likewise be utilized with the predictive railroad crossing notification system 300 to accommodate different users having different devices and different user preferences. In contemplated embodiments, the virtual assistant components 1338 may communicate with a back end system 1340 that may be cloud-based to assist in the processing and parsing requests, obtaining additional information, retrieving data from the database 326 (or any other database accessible to the system), and returning crossing status report. Custom built virtual assistants are possible in further and/or alternative embodiments of the system. Also, contemplated digital assistant technologies may be artificial intelligence (AI) powered assistant beneficially applying machine learning techniques for improved performance. Human virtual assistants are possible in some embodiments of the invention, wherein system users may request and receive cross status information in a hands-free manner.

As a further non-limiting example, the hands free device 1300 may be integrated in a vehicle infotainment system and may act in concert with a connected mobile computing device, or as a stand-alone vehicle infotainment system that does not depend on a personal mobile computing device to operate. In the latter case the stand-alone vehicle infotainment system interacts with the crossing database 326 and the predictive railroad crossing notification system 300 to provide crossing status reports in a hands free manner. The device 1300 can be conveniently used for hands-free requests regarding railroad crossing status with improved safety by a user. For instance, when a driver knows that an upcoming railroad crossing can potentially block traffic, the driver can verbally request the crossing status while continuing to operate the vehicle without taking his or her eyes off the road.

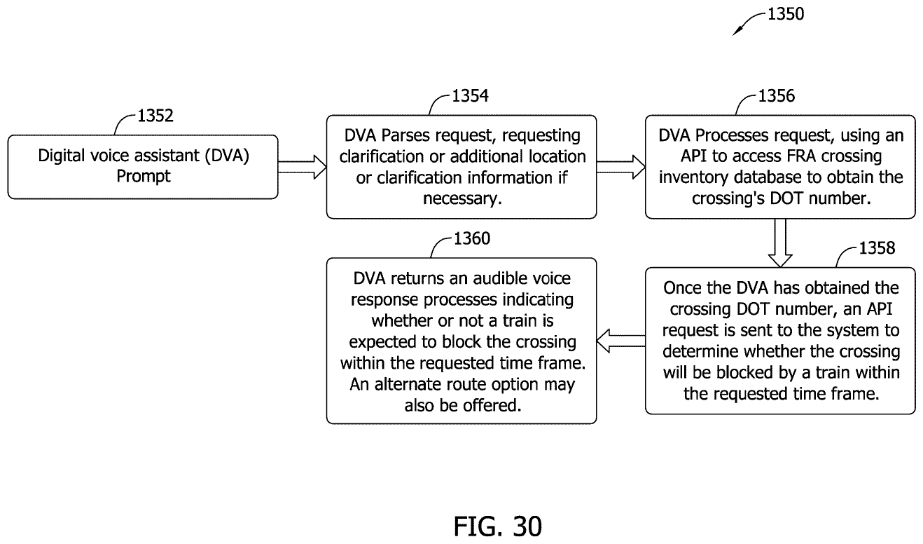

FIG. 30 is an exemplary algorithmic flow chart of processes 1350 performed by the hands free virtual assistant device in providing predictive estimate information for a crossing.

At step 1352 the user, who may be driving, makes a verbal request to the device 1300, using the cross streets of the crossing along with a timeframe of interest. For instance, the user may say the following prompt “Hey Siri, is the railroad crossing at Main Street and 5th Avenue going to be blocked in the next 10 minutes?” The request is received with the device microphone 1336 with the words “Hey Siri” activating the speech processing functionality of the virtual assistant components 1338. In another embodiment, other activation words or phrases may be utilized to activate the virtual assistant functionality. In some cases, an activation input such as a button may be provided on a steering wheel or other location in a vehicle for activation by drivers without taking their eyes off the road, and once the activation is made with the button or other user input selector the system is ready to process the user request which may be spoken thereafter and received by the activated microphone.

At step 1354, the device 1300 via the virtual assistant components provided, parses the request and extracts the location and timeframe keywords (cross-streets and timeframe) from the request. For purposes of step 1354, the device 1300 may communicate with a separate remotely located system to complete the parsing of the request and extracting of time and location keywords, and receive the parsed request and extracted information in return. If additional information to locate the crossing is needed, the virtual assistant components responds to the user via the device speaker 1334 in human speech, requesting any additional information needed. For instance, and following the example above, the device 1300 may prompt the user for the name of the City in which the crossing of interest at Main Street and 5th Avenue is located. Prompts and requests for additional information may also be provided on the device display 1332 for reply by a passenger or other non-driver at their convenience in a safe manner.

At step 1356, the device 1300 via the virtual assistant components provided uses an API to obtain the crossing's unique DOT ID Number from the Federal Railroad Administration's Crossing Inventory Database (shown at 326 in FIG. 29) or another independent track or railroad asset database that is accessible to the system though the device 1300 and any associated cloud-based back end system that supports the functionality of the device 300.

At step 1358, the device 1300 via the virtual assistant components provided (separately or in combination with any back end system that may be present) uses the crossing's DOT ID Number obtained from step 1356 in an API to access the predictive railroad crossing notification system 300 to learn if a train is predicted to reach and block that crossing within the requested timeframe.

At step 1360, the device 1300 provides crossing report information back to the user based on knowledge that it has accumulated in steps 1354, 1358 and 360 regarding the crossing of interest in the user's prompt at step 1352. The crossing report includes return metrics which are responsive to the user's request. The crossing report is provided in human speech form via the device speaker(s) and/or on the device display as well for the benefit of a driver, a passenger or person who is not in a vehicle but would likewise benefit from the crossing report information.

In contemplated examples of the operation of the device 1300 via the algorithm 1350 may generate one of the following replies to the above example crossing status request of the user.
1. “The crossing ahead at Main Street and 5th Avenue looks like it might be blocked for approximately 15 minutes”.
2. “The crossing ahead at Main Street and 5th Avenue looks like it is going to be clear, at least for the next 15 minutes”.
3. “The crossing ahead at Main Street and 5th Avenue is blocked by a passing train right now, but it looks like it is going to be clear in about 5 minutes”.
4. “The crossing ahead at Main Street and 5th Avenue is blocked by a passing train right now. Would you like to consider an alternate route to avoid this delay?
5. “I don't have sufficient information right now on the crossing at Main Street and 5th Avenue”.
6. “I cannot locate any information on that crossing”.

For response 1 above, the user who is now informed of the blocked crossing may take action to avoid it, such as delaying the start of a vehicle trip for 15 minutes; spending the next 15 minutes by refilling their vehicle, buying food or drink or visiting a shop to buy something needed to avoid arrival at the crossing while it is blocked; or proceeding along a different route in view of the information provided. The user can accordingly act and plan to arrive at the crossing at least 15 minutes later and avoid the blockage by the train, or to choose a different route that does not include the blocked crossing.

For response 2 above, the user who is now informed that the crossing is clear for 15 minutes may take action to pass through it before the expiration of the 15 minute period. For instance, the user may start the vehicle trip earlier if needed, and refrain from any other action that may delay passage through the crossing in the 15 minute period.

For response 3 above, the user who is now informed that the crossing is blocked for a relatively short time may decide whether the delay is tolerable (and therefore do nothing to avoid it) or proactively take action to avoid the crossing for at least five minutes.

For response 4 above, if the informed user responds “Yes” the device can verbally supply suggested rerouting information to avoid the blockage such as those included in the examples described above in relation to FIGS. 18-22 or to automatically undertake a route change in a vehicle mapping or navigation system.

For responses 5 and 6 above, the user is informed that the crossing status cannot be determined. The system acknowledges the user's request, however, so the user knows that the attempt to locate predictive crossing status was made and the system is operational. The user may choose to retry the request or accept uncertainty whether the crossing of interest is or will be blocked.

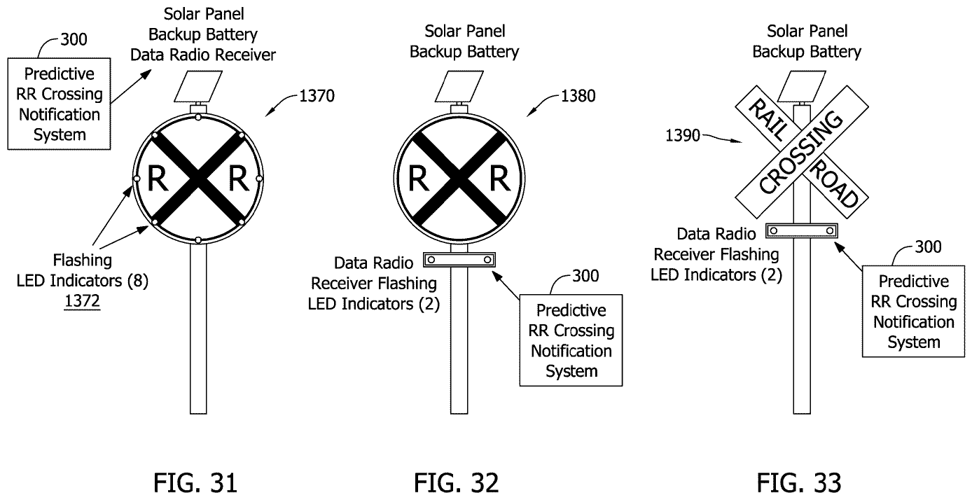

FIGS. 31-33 illustrate exemplary subsystems including exemplary railroad crossing signage which may serve as crossing system devices 400 in the system shown in FIG. 25-27. FIGS. 31-33 show that the predictive railroad crossing notification system 300 may beneficially be used to enhance the conspicuity of otherwise passive railroad crossing signage and to heighten driver attention when a train is in the vicinity or on approach and about to pass through an at-grade railroad crossing.

Passive railroad crossings, generally found in more rural areas, generally do not feature gates and/or flashing lights because line power supplies may not be available and the frequency of train or vehicular traffic may not warrant a more expensive, active crossing warning system. Consequently, conventional passive railroad crossings typically only include one or more static signs located adjacent the crossing to advise drivers of the crossing, with the expectation that drivers will be alert to any trains that may be visible near the crossing. Too often, however, drivers who frequently travel across passive such crossings lose their sensitivity to such static visual objects, which can too easily become part of background scenery. A resultant lack of driver attentiveness at passive crossing sites is one of the reasons why 40% of train-automobile collisions each year occur at passive crossings.

As shown in FIGS. 31-33, with its ability to predict when crossings might be blocked by passing trains, the predictive railroad crossing notification system 300 can send a wireless data message to railroad crossing signage equipped with solar powered data receivers and control elements which are responsive to the wireless data messages concerning estimated time of arrival of an approaching train to flash high-intensity, LED lights attached or adjacent to the passive crossing signage. The passive signage, thus enhanced, will be more conspicuous, attracting driver attention during those periods when a train is likely to be passing over the crossing.

FIG. 31 is a first elevational view of first exemplary embodiment of a railroad crossing signage 1370 for a railroad crossing which is responsive to the predictive railroad crossing notification and traffic control system shown in FIGS. 26A, 26B, and 27. The signage 1370 includes a weatherproof solar panel and rechargeable battery power supply and a data radio receiver mounted atop a round sign. Other mounting locations are possible, however, including but not limited to just below the sign or behind the sign. While the solar panel and rechargeable battery power supply and a data radio receiver are illustrated together as a group at a common location (e.g., atop the sign, these components could alternatively be located at respectively different locations if desired. For example, the data radio may be mounted on the signpost just beneath the railroad crossing sign while being powered by a solar panel and battery charger located atop the signpost. A backup battery may optionally be provided.

The round sign is attached to a support port that is anchored in the ground at or near the crossing site. The round sign is elevated from the ground on the post and includes standard road sign colors and the familiar railroad crossing symbol including an X with an R on both sides. The round sign is outfitted with a plurality of LEDs 1372 spaced from one another on the outer circumference or outer perimeter of the sign. In the example shown, eight LEDs 1372 are provided and spaced equally from one another on the outer perimeter, while more or less LEDs could be provided in another embodiment. The LEDs 1372 are connected to the power supply and activated by controller components in response to data received by the radio receiver concerning predicted estimation of train arrival. The LEDs 1372 are flashed at a predetermined frequency on the perimeter of the sign to draw the attention of a motorist to the sign and mitigate any tendency of the signage to blend into the background scenery from the perspective of an inattentive driver.

As an indication of system health, the LED lights 1372 can be made to flash periodically while in a quiescent state, for example, once per minute. And when the system transmits a data radio message regarding a train due to arrive soon at the crossing, the flash rate may then accelerate to a higher frequency flash rate, for example, once every two seconds. Because the predictive railroad crossing notification system 300 not only determines when the crossing will be blocked by a train but also for how long, the data message that activates the heightened conspicuity state can also convey timing information regarding how long to flash the train-on-approach message before returning to a quiescent state. As such, the LEDs are flashed at a higher frequency in view of expected train arrival and blocked crossing duration while being flashed at a lower frequency when no train is expected and the crossing is not blocked. The lower frequency reduces power consumption in a low power sleep state while still positively indicating that the system is working. The exemplary high and low frequency thresholds may be varied in different embodiments and may be greater or lesser than the values mentioned above. In further embodiments, distinctive slow flash cadences for the LEDs can also signal system health information such as the status of battery charging or the status of cellular data radio reception.

FIG. 32 is an elevational view of second exemplary embodiment of a railroad crossing signage 1380 for a railroad crossing which is responsive to the predictive railroad crossing notification and traffic control system shown in FIGS. 26A, 26B and 27. The signage includes a round sign similar to the one in FIG. 31, with a data receiver shown below the sign and solar power supply located above the sign. The data receiver is equipped with a number of high intensity LEDs 1372 as shown. As such, the LEDs 1372 are included in the data receiver rather than on the perimeter of the round sign. The LEDs are operable with high and low frequency flashing in a similar manner to that described above and with similar benefits to attract driver attention to the sign when notified by the predictive railroad crossing notification system 300 of estimated train arrival time and blocked crossing duration estimated time. While two LEDs are shown in the illustrated embodiment, more than two LEDs may be provided in another embodiment as desired. In a further embodiment, LEDs could be provided on the sign as shown in FIG. 31 and on the data receiver as shown in FIG. 2.

FIG. 33 is an elevational view of third exemplary embodiment of a railroad crossing signage 1390 for a railroad crossing which is responsive to the predictive railroad crossing notification and traffic control system shown in FIGS. 26A, 26B and 27. Instead of a round sign like that shown in FIGS. 31 and 32, the sign 1390 includes the familiar crossbuck in the form of an X-shaped sign having elongated rectangular sections intersecting one another, with one of the sections including the words RAIL ROAD and the other section including the word CROSSING. The data receiver with LEDs is shown below the X-shaped sign and the solar power supply is shown above the X-shaped sign. The data receiver is operable to flash the LEDs with high and low frequency in a similar manner to that described above and with similar benefits to attract driver attention to the sign when notified by the predictive railroad crossing notification system 300 of estimated train arrival time and blocked crossing duration estimated time. While two LEDs are shown in the illustrated embodiment, more than two LEDs may be provided in another embodiment as desired. In further embodiments, LEDs could be provided on the X-shaped sign instead of the receiver, or LEDs could be provided on both of the data receiver and the X-shaped sign as desired.

While exemplary signage is shown and described in FIGS. 31-33, further variation in signage is possible in further and/or alternative embodiments. The use of solar power supplies, data receivers and high intensity LED lights may be extended to similar and different types of signage directed to non-drivers such as pedestrians, hikers, cyclists and recreationalists present in and around railroad corridors as non-limiting examples of persons who would benefit from attention grabbing signage activated to provide advance warning of predicted train arrival. Also, the use of data receivers and LEDs as described may be employed in areas where line power supplies exist or can affordably be provided, such that the data receivers and LEDs need not be solar powered in all embodiments. Likewise, the flashing LED functionality as described may be implemented with wired communication instead of wireless communication to another device in a manner that negates a need to have a data receiver mounted on the signage as shown in the exemplary embodiments above, but which still operates the LEDs in response to data messages from the predictive railroad crossing notification system 300.

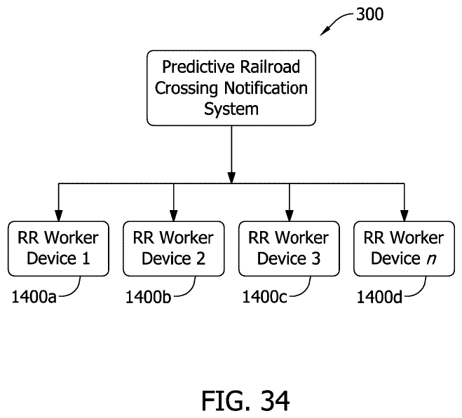

FIG. 34 is a block diagram of an exemplary subsystem of the exemplary predictive railroad crossing notification and traffic control system 100 making clear that the predictive railroad crossing notification system 300 is scalable to communicate with any number n of railroad worker devices 1400a, 1400b, 1400c, and 1400d. Operating in concert with the predictive railroad crossing notification system 300, the railroad worker devices 1400a, 1400b, 1400c, and 1400d provide simpler alternatives to known Electronic Roadway Worker Protection (eRWP) systems and devices for workers at locations that are temporary and frequently change. For instance, a railroad worker crew may be repairing track, replacing ties, adding ballast, or working on overhead signals for days or weeks at a time. It is critical that these workers be informed regarding approaching trains for the protection of equipment and workers.

Railroad worker protection (CFR 49 Part 671) includes the Federal Employers' Liability Act (FELA) for on-duty injuries caused by unsafe conditions or equipment, Federal Railroad Safety Act (FRSA) whistleblower protections for reporting safety violations, and Roadway Worker Protection (RWP) regulations that mandate on-track safety programs, training, and equipment to prevent accidents on railway tracks. These protections provide legal recourse, safety standards, and prevention measures for railroad workers across the nation.

Electronic Roadway Worker Protection (eRWP) safety systems have been developed to serve the need and requirements for railroad worker protection. Known eRWP systems incorporate portable and fixed electronic sensors to detect approaching trains or vehicles and alert crew workers in a work zone. Accordingly, eRWP systems complement existing safety rules for railroad workers and reduce accidents caused by human error. Existing eRWP systems typically include physical train detection modules located at designated work zone limits, train alert modules to extend safety alerts, and wearable devices for workers to receive notifications. Some eRWP systems also offer an optional onboard unit for train operators and a web-based dashboard for monitoring and reporting.

The predictive railroad crossing notification system 300 is operable to provide predictive estimates of train arrival at any point between fixed locations of the railroad crossings as well at the fixed location crossings per the examples above. Railroad worker safety is therefore possible at much lower cost and with vastly reduced complexity compared to known eRWP systems. Specifically, the predictive railroad crossing notification system 300 may realize eRWP alert functionality without train detection modules, repeaters, or special locomotive equipment that needs to be transported and set up at the worker zones along railroad corridors. By establishing temporary locations along the railroad track where trains will arrive (rather than fixed crossing locations) in which the railroad workers are present, the predictive railroad crossing notification system 300, based on its knowledge of operating train data, can reliably determine estimated train arrival information for the temporary worker locations without requiring physical train detection at limits of the work zone which conventional eRWP systems require. Likewise, wireless networking gear along the railway corridors that is needed for conventional eRWP systems is not required in the operation of the predictive railroad crossing notification system 300. Lower cost but highly reliable notification of approaching trains is therefore realized by the system 100.

In contemplated embodiments, the temporary worker location and work zone may be identified to the predictive railroad crossing notification system 300 with GPS coordinates or by milepost of associated railroad track. Based on the identified location, the predictive railroad crossing notification system 300 can therefore compute the distance of an operating train from the identified worker location or work zone location and generate a train ETA with advance notice of, for example, at least 15 minutes for workers to prepare for arrival of a train. The predictive railroad crossing notification system 300 may continue to provide predictive train ETAs for successive trains to the identified location when workers are present and until the associated work is completed. Once work is completed, the temporary worker or work zone location may be deleted or disregarded by the predictive railroad crossing notification system 300 and no further estimates of train arrival will be generated.

As those in the art would know and appreciate, track warrants are instructions or official notices given to locomotives to modify speed and movement when workers are going to be encountered along the rail corridor. When track warrants are prepared and issued, the temporary locations where work is being performed could also be the time when those way points are entered into, accepted and/or identified by the system for the generation of predictive alerts of train ETAs to railway workers at temporary work locations.

Form A and Form B warrants are two common types of Track Bulletins which modify permanent rules and instructions such as Employee Timetables and Operating Rules, and to notify of conditions to meet safety requirements for workers.

Form As are used to issue temporary speed restrictions, notify of unsafe conditions, notify of changes to the railroad signal system, protect tracks removed from service, authorize movement against the current of traffic, protect tracks blocked with equipment, or change or modify any of the operating rules, general orders, or special instructions.

Form Bs are used to protect workers and equipment in work zones on the track. They notify of the time that a work zone is in effect, the foreman in charge, the milepost limits, and whether trains must stop before entering the work zone and request permission to enter the work zone from the foreman in charge.

Form A and Form B warrants may therefore serve as further sources of information to make the desired train ETA estimates and/or to provide consistent instructions to workers in notifications made by the system through the railroad worker devices.

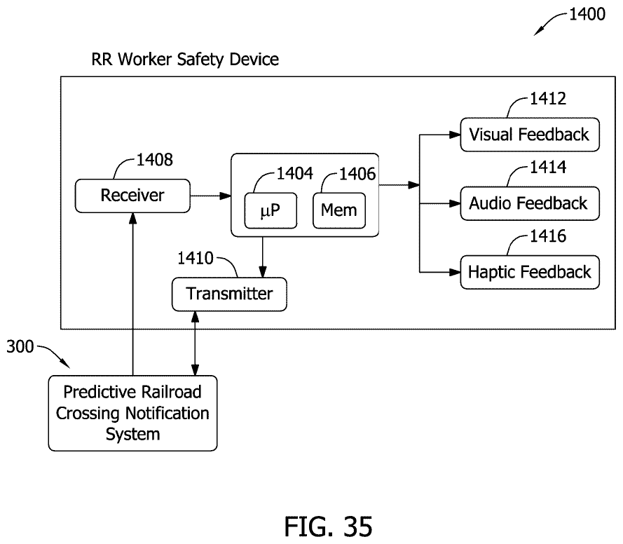

An example of a railroad worker device 1400 is shown in FIG. 35 that may be advantageously used in the system 100. The device 1400 includes a controller having a microprocessor 1404 and a memory 1406. The device 1400 further includes a receiver 1408 and a transmitter 1410 for receiving and sending wireless data and information signals from and to the predictive railroad crossing notification system 300. In some embodiments, the receiver 1408 and transmitter 1410 could effectively be combined into one element known as a transceiver. In another embodiment wherein hard wired communication is employed, the receiver 1408 and transmitter 1410 may be considered optional and need not be included, and other communication interfaces may be appropriately included in the device 1400.

The device 1400 may also include a visual feedback element 1412, an audio feedback element 1414 and a haptic feedback element 1416. In contemplated embodiments the device 1400 is a portable, battery-powered device that may be carried by a railroad worker such as a smartphone device or a tablet device. In further embodiments the device 1400 may be configured as a wearable device that can be comfortably worn on the worker's body or affixed to the worker's clothing and therefore not as subject to being lost or mislaid on the work site. Example wearable devices may include smartwatches, fitness tracker devices, eyeglasses and smart clothing as non-limiting examples. In some embodiments, the wearable devices 1400 are existing devices of known eRWP systems that include one or more of such feedback elements. The device 1400 may also be integrated into personal protective equipment used by workers (e.g., helmets, vests and gloves). Still further, the device 1400 may be integrated into worker lanyards and identification elements that workers possess, and the device 1400 may be integrated into tools and equipment that railroad workers may be using in work zones. Still other types of devices 1400 are possible, and in some additional embodiments such devices 1400 may be provided to persons other than railroad workers who may benefit from predictive ETA for trains in identified locations.

The device 1400 receives predictive estimates generated by the predictive railroad crossing notification system regarding expected train arrival at the identified location where the railroad worker(s) reside in a railroad work zone. In some cases, the device 1400 may include location detection elements that can automatically determine device location and communicate the same to the predictive railroad crossing notification system 300 for generating the estimates, or in another example the work zone or worker location data may be input to the system manually. The device 1400 provides advance notice of train arrival at the identified location of the work zone via activation of one or more of the visual, audio and haptic feedback elements 1412, 1414 and 1416. The workers having such devices 1400 may then respond appropriately to the activated feedback elements 1412, 1414 or 1416 to avoid the oncoming train and ensure their personal safety. A notified worker may also interact with co-workers, who may or may not possess a device 1400, toward the goal of ensuring safety of the entire work crew before the train arrives.

The visual feedback element 1412 may include one or more indicator lights or a video display that provides a visual warning of estimated train arrival to a worker withing the work zone. The indicator lights or display may generate visual warnings of the same of different color or of different brightness and intensity as the estimated time of train arrival draws close to provide an escalated sense of urgency to railroad workers. Flashing indicator lights of varying frequency and intensity may also be employed to communicate a sense of urgency as the estimated time of arrival approaches the current time. The indicator lights are designed and operated to draw the attention of railroad workers.

In the case of a display as the visual feedback element 1412, symbolic representations and graphics may be presented on the display to convey that a train is approaching, with train arrival information also being provided. Instructions may also be included on the display regarding actions to be undertaken by the worker and/or coworkers to ensure personal safety of the crew. Different screen displays may be provided with different graphics, different colors, different symbols, and different fonts with different messaging to convey a sense of urgency as the estimated time of arrival approaches the current time. The display 1412 is designed and operated to grab the worker's attention. A countdown timer of the train ETA may be provided on the display for reference by workers.

The audio feedback element 1414 may provide alarm tones or sound alerts that provide an audio warning of an expected time of train arrival. Human speech warnings may also be generated and played through the audio feedback element 1414 including estimated time of train arrival information. The audio feedback elements may generate audio warnings of different volume or intensity as the estimated time of arrival nears to provide an escalated sense of urgency to railroad workers. The audio feedback element 1414 is designed and operated to grab the worker's attention. The audio feedback element may garner the attention of the worker at the identified location before the visual feedback element one does, providing a desired degree of redundancy in the notifications provided.

The tactile feedback element 1416 may provide tactile sensation (e.g., vibration or type of haptic feedback) to a worker as a warning of an predicted train arrival. The tactile feedback elements 1416 may generate tactile sensation of increasing intensity or increasing frequency as the estimated time of arrival nears to provide an escalated sense of urgency to the railroad worker. The tactile feedback element 1416 is designed and operated to grab the worker's attention. The tactile feedback element may garner the attention of the worker at the identified location before the visual feedback element or audio feedback element does, providing an additional desired degree of redundancy in the notifications provided. Depending on the tasks being performed by workers and the nature of the work being completed, the worker may not be able to see or hear visual and audio alarms when first made, but will be able to feel the alert when the tactile element is activated.

The feedback elements 1412, 1414 and 1416 may be operated simultaneously or in sequence depending on system setup and/or user preferences, and the feedback elements 1412, 1414 and 1416 may continue to operate unless and until a worker acknowledges the warnings provided. The feedback elements 1412, 1414 and 1416 may be operated at different times with different intensity in some embodiments in different notification phases depending on how large or small the difference is between current time and the train ETA. For example, the feedback elements 1412, 1414 and 1416 may be activated at a first time (e.g., 15 minutes before estimated train arrival) at a first intensity, re-activated at a second and subsequent time (e.g., 10 minutes before estimated train arrival) at a second and greater intensity than the first intensity, and finally activated at a third time (e.g., 5 minutes before estimated train arrival) at a third intensity greater than the second intensity.

The predictive railroad crossing notification system 300 may communicate with multiple devices 1400 at the same work zone location to alert numerous workers simultaneously of an approaching train with ample advance notice to take safety measures. Alerts about approaching railroad corridor work zones can also be broadcasted by the predictive railroad crossing notification system 300 to cellular data radio devices and visual displays similar to passive crossing warning signage such as that described above. If the workers have multiple devices (e.g., a smartphone and a wearable device) the notifications may be received on each of the multiple devices to provide still further redundance in the notifications provided to various crew workers at the identified location. The predictive railroad crossing notification system 300 can monitor different trains approaching different worker zones and provide specific warnings to each worker zone as needed via the worker devices 1400 present at each identified worker location.

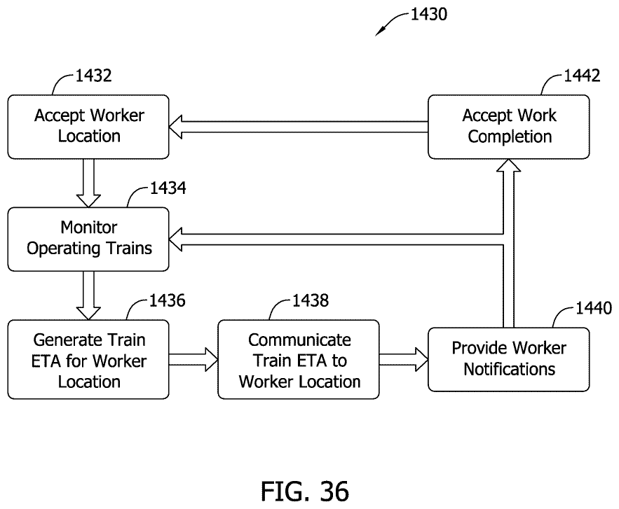

FIG. 36 is an exemplary algorithmic flow chart of processes 1430 performed by the predictive railroad crossing notification system 300 and railroad worker safety devices 400 in providing predictive estimate information and notifications for an operating train at a temporary railroad worker zone.

At step 1432, the worker location is accepted. The worker location may correspond to a railroad crossing or may be distanced from a crossing. The worker location establishes a temporary location for use by the system to provide predictive estimates for train arrival at the work location to worker devices 1400 as described above.

At step 1434 the system monitors operating train location and speed in the manner described above using any of the data sources described. Based on its knowledge of the operating trains and their distance from the identified worker location, the system can generate predictive train ETA for the worker location as shown at step 1436.

At step 1438, the train ETA from step 1436 is communicated to devices 1400 at the worker location. At step 1440 notifications are provided to the workers via the devices 1400 as described above. The system then returns to monitor trains at step 1434 and repeat the steps 1436, 1438 and 1440 for any additional train that is approaching the worker zone. At step 1442, work completion is accepted by the system and the system and no more monitoring of trains is made for the worker location and any corresponding ETA generation, communication and notifications are ceased by the system.

The methodology 1430 is concurrently operable with respect to multiple different worker locations in the same or different railroad corridors operated by the same or different railroad entities. The system and method is scalable to include any number of worker locations and any number of worker devices at each worker location. As noted above, worker notifications at step 1440 are not necessarily limited to devices 1440 but may also be received by the other types of devices described above such as conspicuous signage which may be placed at the worker location and which is also responsive to the predictive railroad crossing notification system 300 to provide advance notification of train arrival to workers. An enhanced degree of redundancy in the notifications provided via personal devices (e.g., smartphones and wearables) and external devices (e.g., conspicuous signage placed about the work zone for reference by workers presents having a line of sight to the signage) may further railroad improve worker safety relative to known eRWP systems.

The methodology 1430 is also operable concurrently with the methodology shown and described above in relation to FIG. 24 and/or the methodology associated with the system features shown and described in relation to FIGS. 25-31. As such, the system can provide predictive crossing estimates as well as predictive worker location estimates of train arrival for a number of simultaneously operating trains. The system is particularly beneficial for crossings wherein no physical train detection exists, and beneficially eliminates any requirement for physical train detection to meet railroad worker safety requirements.

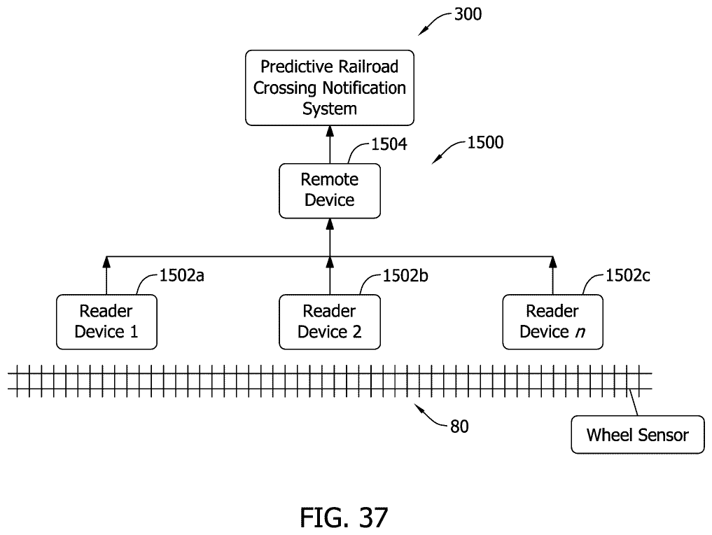

FIG. 37 schematically illustrates a railroad car reader subsystem 1500 in communication with the predictive railroad crossing notification system 300. The system 1500 includes a plurality of reader devices 1502a, 1502b, 1502c located at predetermined locations along a railroad track 80. In contemplated embodiments, the reader devices 1502 are processor based devices including a controller having a microprocessor and a memory with reader circuitry that receives or retrieves train data as further explained below. The reader devices 1502a, 1502b, 1502c are further in communication with a remote device 1504 that aggregates train data from the plurality of reader devices 1502a, 1502b, 1502. The remote device 1504 may provide data to the predictive railroad crossing notification system 300 for generating predictive estimates and generating or supplying notifications for railroad crossings or worker locations along the railroad track 80 as described above. The system 1500 is scalable to include any number n of reader devices 1502 along the same or different railroad tracks 80 to simultaneously collect data on any given number n of trains operated by the same or different railroad entities in different locations.

In certain contemplated embodiments, wheel detection sensors may be provided on the railroad track 80. The wheel sensors may be any type of sensor such as, but not limited to, inductive wheel sensors that may be connected to the rails of the track 80 and output signals to an evaluator device that analyzes electromagnetic field to detect a presence of a wheel. In some embodiments, the wheel sensor subsystem could also provide velocity information by measuring the cadence and timing of successive wheel sensor activation pulses. The velocity information from the wheel sensor system(s) may provide further inputs to the predictive railroad crossing notification system 300 to make the desired predictive estimates.

In contemplated embodiments, the wheel sensor system(s) may provide input signals to the reader devices 1502 to power up and interrogate the transponders 1508 when the train is present at the locations of the respective reader devices 1502. In the absence of a train (via no wheel detection by the wheel sensor systems) the reader devices 1502 may assume low power sleep states for reduced power consumption. The reader devices 1502 may be battery powered in some embodiments and further may include solar powered charging of rechargeable batteries for use in remote locations. In some cases, the reader devices could alternatively be powered by line power supplies.

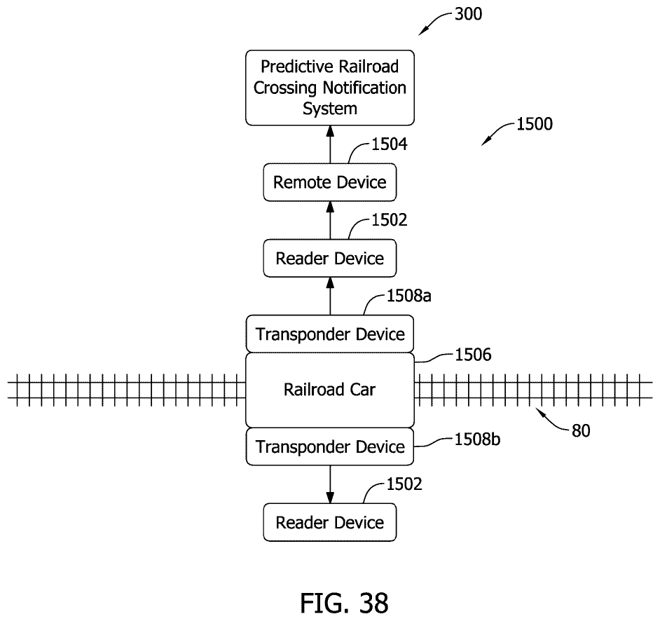

FIG. 38 schematically illustrates a railroad car interface with a portion of the subsystem shown in FIG. 37. In the example shown, the railroad car 1506 includes a pair of transponder devices 1508a, 1508b provided on opposing sides (sometimes referred to as side A and side B) of the railcar. The transponder devices 1508a, 1508b may be Radio Frequency Identification (RFID) tags in a contemplated embodiment. The transponder devices 1508a, 1508b may be integrated in a processor-based device including a controller having a microprocessor and a memory with circuitry providing railroad data outputs to the transponder devices 1508, 1508b which may be communicated to the reader device 1502. The transponder devices 1508, 150b may further be integrated in or in communication with a sensor system which detects the railroad car data of interest. The transponder devices 1508a, 1508b respectively communicate with reader devices 1502 that are also arranged as a pair on opposing sides of the railroad track 80. Arranging the transponder devices and reader devices in pairs provides desired system redundancy as well as ability to determine how each railroad car is oriented in the train.

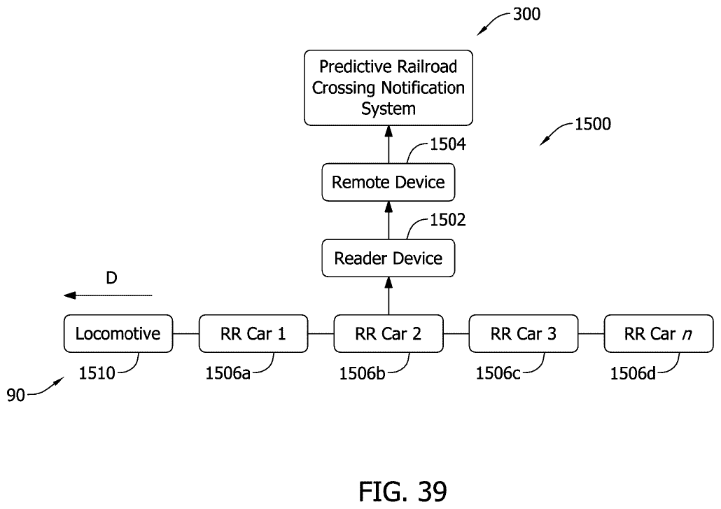

FIG. 39 schematically illustrates an operation of the interface and subsystem of FIGS. 38 and 39 collecting data from railroad cars in a moving train 90 on approach to a railroad crossing or railroad worker location. The train 90 includes a locomotive 150 and n number of railroad cars 1506a, 1506b, 1506c that are each provided with the transponder device 1508 or a pair of transponder devices 1508 (FIG. 38). The train is moving in the direction indicated by arrow D along the railroad track 80 (FIGS. 37 and 38), and as each railroad car 1506a, 1506b, 1506c passes the reader device 1502 (or pair of reader devices 152) the railroad data for each respective car is communicated to the reader device 1502 by the transponder device 1506 and, in turn, to the remote device 1504 which may serve as a train data source for the predictive estimates made by the predictive railroad crossing notification system 300. Communications between the reader devices 1502 and the remote device 1504 may be made wirelessly in contemplated embodiments using, for example, mesh network technologies. More than one remote device 1504 may be implemented to serve different groups of reader devices 1502 as appropriate or as desired to serve different geographic entities or different railroad entities. The system is generally scalable to encompass as many devices as necessary to monitor vast operating train activity across desired geographic areas including multiple and different railroad corridors and routes.

The transponder devices 1508 and reader devices 1502 advantageously provide train location and behavior information that can be used independently from the other data sources described above or to augment the data obtained from the other data sources described above to optimize accuracy and reliability of predictive estimates and related crossing status information reporting and notification described above, as well as improving worker safety at locations along railroad tracks 80 that do not coincide with public or private railroad crossings. In contemplated embodiments, the trackside reader devices (e.g., RFID readers) are primarily used to catalog and verify the presence of railcars 1506 within the consist, or string of cars that are assembled behind the locomotive 1510 to form the train 90. As the locomotive 1510 and its consist leave a switching yard it is important to verify that those cars 1506 are properly underway. Accordingly, transponders such as RFID tags are affixed to all railcars 1506 and are powered up by the trackside reader devices 1502 (called AEI Readers) that provide energy to power the transmission of railcar ID information from the railcar-mounted transponders and then receive that broadcasted information.

For purposes of the predictive railroad crossing notification system 300, information can be obtained from each railcar 1506 in multiple locations along a railroad corridor, with the performance of the system improving as the number of reader devices increases along the railroad tracks 80. In addition to providing railcar ID information close to classification yards, other important metrics can be collected by trackside reader devices 1502 such as, for example only, the temperature of refrigeration cars, verification that vibration and ride quality is within acceptable limits, and cargo security information.

Because railcars are manufactured to standardized lengths, if sufficient number and density of reader devices 1502 are positioned along railroad corridors and if a sufficient number of railcars are outfitted with transponder devices 1508, an accurate assessment of the velocity of the train 90 is possible as it passes by the reader locations and the length of the consist (i.e., the cumulative length of all of the railroad cars 1506 can be sufficiently determined.

The train velocity can be determined based on the timing of data communication between the reader devices 1502 and the transponder device 1508 of the adjacent car. When the transponder devices 1508 are located in a known position on each of the railroad cars 1506 the distance between them is known or can be determined when connected in the consist of the train 90. The length of each railroad car may be identified by each transponder device 1506 such that the system can determine train velocity based on two successive data transmissions for adjacent cars in the consist having the same length or a different length. Common railroad box cars typically range from about 50 ft to about 60 ft long, while specialty cars can approach about 90 ft in length. Real-time velocity determinations and also real-time detection in changes of train velocity are possible via data collected in the system 1500.

As one example, if the distance between transponder devices for cars of equal length is 60 feet and the data communication for successive cars is 2 seconds apart, the velocity is computed as the distance over time or 60 ft/2 sec, which amounts to 30 ft/see or about 20.5 mph. As another example, if the distance between transponder devices for cars of unequal length is determined to be 80 feet and the data communication for successive cars is 2 seconds apart, the velocity is computed as the distance over time or 80 ft/2 sec, which amounts to 40 ft/see or about 27.2 mph. Once the velocity is known the predictive railroad crossing notification system 300 may predictively determine ETA of the train based on the distance between the fixed location of the reader device 1502 and a crossing or worker location that the train is approaching which is known to the system 300.

Iterative velocity determinations can be made for multiple cars in the consist and compared to one another to assess system health and reliability. Different velocity determinations within a short period of time indicates an error condition, while consistent velocity determinations provides confirmation of healthy system operation and accuracy. Velocity determinations made via data from different reader devices 1502 at different locations may also be compared to one another and may be utilized to detect patterns of velocity changes of the train 90 over the course of a route that may be used to improve reliability of predictive estimates.

The length of the consist may be determined as the cumulative sum of distances between reporting transponder devices 1508 to the reader device 1502. As a simple example, if 50 cars are read by the reader device 1502 and the distance between transponder devices 1502 is uniformly 50 ft, the length of the consist is the product of the number of cars and the distance or 2500 ft. The length of the locomotive may optionally be added for purposes of estimated blocked crossing duration by the predictive railroad crossing notification system 300 but in this example would not materially change the blocked crossing estimate since the locomotive length would be a very small fraction of the length of the consist.

As another example, the length of the consist may likewise be easily determined for consists having cars of different length based on known distances between the transponder devices 1508 in each car 1506, or by determining the distances between the transponder devices 1508. The length of the consist would be the sum of the distances between the reporting transponder devices to the reader device 1502. An example is provided in the following table, which could be continued for a consist having additional cars.

TABLE 1

| Transponder | Transponder Device | Cumulative Consist |
|---|---|---|
| Device | Distance (ft) | Length (ft) |
| 1 | N/A | 0 |
| 2 | 60 | 60 |
| 3 | 80 | 140 |
| 4 | 55 | 195 |

Once the train length is known, the predictive blocked crossing estimate can be generated by the predictive railroad crossing notification system 300. The predictive blocked crossing duration estimate is equal to the train length divided by the velocity. The data and determinations made through the reader devices 1502 may be provided as additional inputs to the system shown in FIG. 25, and may be compared to the data and determinations made through the train control system 200 and train sensing system 104 to provide a degree of system redundancy and self-diagnosis of error conditions or self-correcting predictive estimates based on intelligent reasoning and associated algorithms. Predictive estimates and notifications based on data and determinations made through the reader devices 1502 may likewise be made in the systems shown and described in FIGS. 26-35 and in the methodology shown and described in relation to FIG. 36.

While exemplary transponder and reader devices have been described for the system 1500, variations are possible and may likewise be employed with similar functionality and benefits.

The above-described embodiments of the disclosure may be implemented using computer programming or engineering techniques including computer software, firmware, hardware or any combination or subset thereof, wherein the technical effects described above are achieved. Any such resulting program, having computer-readable code means, may be embodied or provided within one or more computer-readable media, thereby making a computer program product, (i.e., an article of manufacture), according to the embodiments described above. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Such computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

The applications described above are flexible and designed to run in various different environments without compromising any major functionality. In some embodiments, the system includes multiple components distributed among a plurality of processor-based devices. One or more components are in the form of computer-executable instructions embodied in a computer-readable medium. The systems and processes are not limited to the specific embodiments described herein. In addition, components of each system and each process can be practiced independently and separately from other components and processes described. Each component and process can also be used in combination with other components and other processes.

One or more computer-readable storage media may include computer-executable instructions embodied thereon for the computer devices described. For example, the predictive railroad crossing notification system 300 as described may include a memory device and a processor in communication with the memory device, and when executed by the processor in each respective device the computer-executable instructions may cause the processor to perform one or more algorithmic steps of a method such as the method described and illustrated in the examples of FIGS. 24 and 36 and other algorithmic features accompanying the inventive systems and sub-systems described in FIGS. 1-23, 25-35 and 37-39. Specifically, the predictive railroad crossing notification system 300 described may include a memory device and a processor in communication with the memory device, and when executed by the processor in each respective device the computer-executable instructions may cause the processor to perform the algorithmic steps described above to provide desired train ETA and blocked crossing duration estimates and any control decision or response to estimate information generated. In other embodiments, however, the functionality of the predictive railroad crossing notification system 300 may be distributed amongst multiple ones of the other devices and systems represented in the system 100.

Having described devices and applicable operating algorithms functionally per the description above, those in the art may accordingly implement the algorithms via programming of the processor-based computing devices. Such programming or implementation of the concepts described is believed to be within the purview of those in the art and will not be described further.

The benefits and advantages of the inventive systems and methods are now believed to have been amply illustrated in relation to the exemplary embodiments disclosed.

An exemplary embodiment of a predictive railroad crossing system operable with respect to a plurality of operating trains to proactively improve railroad safety notification and traffic control decisions has been disclosed. The system includes a centralized processor based-device operable to: iteratively receive at a predetermined interval real-time operating data for each of the plurality of operating trains, wherein the received real-time operating data for each one of the plurality of trains includes locomotive location data and velocity data; identify one or more public or private railroad crossings that each locomotive of the plurality of operating trains will approach; based on the received locomotive location data, determine a distance between each locomotive and the respective one of the plurality of identified public or private railroad crossings; and based on the determined distances and the locomotive velocity data, predictively estimate a time of arrival of the locomotive at each respective one of the plurality of identified public or private railroad crossings. The system also includes a plurality of processor-based devices remotely located from the centralized processor based device and each receiving the predictively estimated time of arrival of the locomotive for respectively different ones of the identified public or private railroad crossings, thereby facilitating specific decisions and actions to be taken in advance of the respective predictively estimated time of arrival of the locomotive at the identified public or private railroad crossings to improve safety on the roadway at each of the plurality of railroad crossings.

Optionally, the locomotive location data and velocity data for the plurality of operating trains may be generated in the operation of data radio devices. The data radio devices may be onboard the respective locomotives of the plurality of trains. The data radio devices may provide infrastructure support of a train control system. The locomotive location data and velocity data may be generated by administrative functions of radio network communications.

As further options, the real-time operating data for each of the plurality of operating trains may include head end location data and rear end location data, and the centralized processor based-device may be operable to determine the length of each train based on the head end location data and rear end location data. Based on the train length data, the centralized processor based-device may be operable to predictively estimate a blocked crossing duration time for the respectively different ones of the identified public or private railroad crossings. The plurality of processor-based devices may be remotely located from the centralized processor based device and may each receive a respective one of the predictively estimated blocked crossing duration times, thereby facilitating specific decisions and actions to be taken in advance of the estimated blocked crossing duration times at the identified public or private railroad crossings to avoid delay at the identified public or private railroad crossings by blocked crossings.

The plurality of processor-based devices in the system may include at least one hands free virtual assistant device. The hands free virtual assistant device may be configured to receive a verbal request for crossing status from a user, and return the crossing status to the user based on information output from the centralized processor based-device. The hands free virtual assistant device may be configured to more specifically request identifying information for a crossing referenced in the verbal request. The hands free virtual assistant device may also be configured to: consult a crossing data base to locate an identification number for the crossing referenced in the verbal request; and communicate the identification number to the centralized processor based-device; and receive crossing status information corresponding to the crossing with the identification number from the centralized processor based-device. The received crossing status information may include an estimated time of train arrival and an estimated blocked crossing duration time for the crossing with the identification number. The hands free virtual assistant device may be configured to audially return the crossing status to the user. The hands free virtual assistant device may also be configured to visually return the crossing status to the user. The hands free virtual assistant device may be a mobile phone or a vehicle infotainment system.

The plurality of processor-based devices may optionally be associated with signage equipped with a plurality of lights responsive to the predictively estimated time of arrival of the locomotive. The plurality of lights may be LED lights. The plurality of lights may be located on an outer perimeter of a sign. The signage may be further equipped with a data radio receiver, the plurality of lights included on the data radio receiver. The data radio receiver and the plurality of lights may be solar powered. The plurality of lights may be flashing lights. The plurality of lights may be flashed at a higher frequency in response to the predictively estimated time of arrival of the locomotive and a lower frequency in an absence of a predictively estimated time of arrival of a locomotive. The signage may include a crossbuck.

The centralized processor based-device may be further operable to suppress the predictively estimated time of arrival of the locomotive unless the predictively estimated train arrival is within a predetermined minute window of time. The predetermined interval may be about one minute.

The centralized processor based-device may also be further configured to: accept railroad worker location data; determine a distance between an operating locomotive location and the accepted railroad worker location; and based on the determined distance and locomotive speed, predictively estimate a time of arrival of the locomotive at the accepted railroad worker location. The system may also include at least one railroad worker device remotely located from the centralized processor based device and receiving the predictively estimated time of arrival of the locomotive for the accepted railroad worker location. The at least one railroad worker device may include a visual feedback element, an audio feedback element or a haptic feedback element. The at least one railroad worker device may be a wearable device configured to notify a worker of the predictively estimated time of arrival of the locomotive.

As further options, the locomotive location data and velocity data for the plurality of operating trains may also be generated by trackside reader devices. The trackside reader devices may be RFID devices.

Another embodiment of a predictive system operable with respect to a plurality of operating trains to proactively improve safety at a railroad worker location has been disclosed. The system includes a centralized processor based-device operable to: iteratively receive at a predetermined interval real-time operating data for each of the plurality of operating trains, wherein the received real-time operating data for each one of the plurality of trains includes locomotive location data and velocity data; accept location data for at least one work zone for a railroad worker crew; based on the received locomotive location data and accepted location data, determine a distance between at least one of the locomotives and the at least one work zone; and based on the determined distance and the locomotive velocity data, predictively estimate a time of arrival of the locomotive at the at least one work zone without requiring physical train detection proximate the proximate the work zone. The system also includes at least one processor-based railroad worker device remotely located from the centralized processor based device and receiving the predictively estimated time of arrival of the locomotive at the at least one work zone.

The at least one processor-based railroad worker device may be a wearable device. The at least one processor-based railroad worker device may include a visual feedback element. The at least one processor-based railroad worker device may include an audio feedback element. The at least one processor-based railroad worker device may include a haptic feedback element. The centralized processor based-device is further operable to: identify one or more public or private railroad crossings that each locomotive of the plurality of operating trains will approach; based on the received locomotive location data, determine a distance between each locomotive and the respective one of the plurality of identified public or private railroad crossings; based on the determined distances and the locomotive velocity data, predictively estimate a time of arrival of the locomotive at each respective one of the plurality of identified public or private railroad crossings; and communicate the predictively estimate a time of arrival of the locomotive to remotely located devices respectively providing notifications to vehicles and persons approaching the respective identified public or private railroad crossing.

The centralized processor based-device may also be operable to: predictively estimate a blocked crossing duration time for each respective one of the plurality of identified public or private railroad crossings; and communicate the predictively estimated blocked crossing time to remotely located devices respectively providing notifications to vehicles and persons approaching the respective identified public or private railroad crossing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A predictive railroad notification system operable with respect to a plurality of operating trains, the system comprising:
a centralized processor based-device operable to:
iteratively receive at a predetermined interval real-time operating data for each of the plurality of operating trains, wherein the received real-time operating data for each one of the plurality of trains includes locomotive location data and velocity data;
identify one or more public or private railroad crossings that each locomotive of the plurality of operating trains will approach;
based on the received locomotive location data, determine a distance between each locomotive and each of the one or more identified public or private railroad crossings; and
based on the determined distances and the locomotive velocity data, predictively estimate a time of arrival of each locomotive at each of the one or more identified public or private railroad crossings; and
a plurality of processor-based devices remotely located from the centralized processor based device and each receiving the predictively estimated time of arrival of each locomotive for the one or more identified public or private railroad crossings, thereby facilitating specific decisions and actions to be taken in advance of the respective predictively estimated time of arrival of each locomotive at the one or more identified public or private railroad crossings.

2. The system of claim 1, wherein the locomotive location data and velocity data for the plurality of operating trains is generated in the operation of data radio devices.

3. The system of claim 2, wherein the data radio devices are onboard the respective locomotives of the plurality of trains.

4. The system of claim 3, wherein the data radio devices provide infrastructure support of a train control system.

5. The system of claim 4, wherein the locomotive location data and velocity data are generated by administrative functions of radio network communications.

6. The system of claim 1, wherein the real-time operating data for each of the plurality of operating trains includes head end location data and rear end location data, and wherein the centralized processor based-device is operable to determine the length of each train based on the head end location data and rear end location data.

7. The system of claim 6, wherein based on the train length data, the centralized processor based-device is operable to predictively estimate a blocked crossing duration time for each of the one or more identified public or private railroad crossings.

8. The system of claim 7, wherein the plurality of processor-based devices remotely located from the centralized processor based device each receive a respective one of the predictively estimated blocked crossing duration times, thereby facilitating specific decisions and actions to be taken in advance of the estimated blocked crossing duration times at the one or more identified public or private railroad crossings.

9. The system of claim 1, wherein the plurality of processor-based devices includes at least one hands free virtual assistant device.

10. The system of claim 9, wherein the hands free virtual assistant device is configured to receive a verbal request for crossing status from a user, and return the crossing status to the user based on information output from the centralized processor based-device.

11. The system of claim 10, wherein the hands free virtual assistant device is configured to more specifically request identifying information for a crossing referenced in the verbal request.

12. The system of claim 10, wherein the hands free virtual assistant device is configured to:
consult a crossing data base to locate an identification number for the crossing referenced in the verbal request;
communicate the identification number to the centralized processor based-device; and
receive crossing status information corresponding to the crossing with the identification number from the centralized processor based-device.

13. The system of claim 12, wherein the received crossing status information includes an estimated time of train arrival and an estimated blocked crossing duration time for the crossing with the identification number.

14. The system of claim 10, wherein the hands free virtual assistant device is configured to audially return the crossing status to the user.

15. The system of claim 10, wherein the hands free virtual assistant device is configured to visually return the crossing status to the user.

16. The system of claim 9, wherein the hands free virtual assistant device is a mobile phone.

17. The system of claim 9, wherein the hands free virtual assistant device is a vehicle infotainment system.

18. The system of claim 1, wherein the plurality of processor-based devices is associated with signage equipped with a plurality of lights responsive to the predictively estimated time of arrival of the locomotive.

19. The system of claim 18, wherein the plurality of lights are LED lights.

20. The system of claim 18, wherein the plurality of lights are located on an outer perimeter of a sign.

21. The system of claim 18, the signage further equipped with a data radio receiver, the plurality of lights included on the data radio receiver.

22. The system of claim 21, wherein the data radio receiver and the plurality of lights are solar powered.

23. The system of claim 18, wherein the plurality of lights are flashing lights.

24. The system of claim 23, wherein the plurality of lights are flashed at a higher frequency in response to the predictively estimated time of arrival of the locomotive and a lower frequency in an absence of a predictively estimated time of arrival of a locomotive.

25. The system of claim 18, wherein the signage includes a crossbuck.

26. The system of claim 1, wherein the centralized processor based-device is further operable to suppress the predictively estimated time of arrival of the locomotive unless the predictively estimated train arrival is within a predetermined window of time.

27. The system of claim 26, wherein the predetermined window of time is about fifteen minutes.

28. The system of claim 1, wherein the centralized processor based-device is further configured to:
accept railroad worker location data;
determine a distance between an operating locomotive location and the accepted railroad worker location; and
based on the determined distance and locomotive speed, predictively estimate a time of arrival of the locomotive at the accepted railroad worker location.

29. The system of claim 28, further comprising at least one railroad worker device remotely located from the centralized processor based device receiving the predictively estimated time of arrival of the locomotive for the accepted railroad worker location.

30. The system of claim 29, wherein the at least one railroad worker device includes a visual feedback element, an audio feedback element or a haptic feedback element.

31. The system of claim 29, wherein the at least one railroad worker device is a wearable device configured to notify a worker of the predictively estimated time of arrival of the locomotive.

32. A predictive system operable with respect to a plurality of operating trains to proactively improve safety at a railroad worker location, the system comprising:
a centralized processor based-device operable to:
iteratively receive at a predetermined interval real-time operating data for each of the plurality of operating trains, wherein the received real-time operating data for each one of the plurality of trains includes locomotive location data and velocity data;
accept location data for at least one work zone for a railroad worker crew;
based on the received locomotive location data and accepted location data, determine a distance between at least one of the locomotives and the at least one work zone; and
based on the determined distance and the locomotive velocity data, predictively estimate a time of arrival of the locomotive at the at least one work zone without requiring physical train detection proximate the work zone; and
at least one processor-based railroad worker device remotely located from the centralized processor based device and receiving the predictively estimated time of arrival of the locomotive at the at least one work zone.

33. The system of claim 32, wherein the at least one processor-based railroad worker device is a wearable device.

34. The system of claim 32, wherein the at least one processor-based railroad worker device includes a visual feedback element.

35. The system of claim 32, wherein the at least one processor-based railroad worker device includes an audio feedback element.

36. The system of claim 32, wherein the at least one processor-based railroad worker device includes a haptic feedback element.

37. The system of claim 32, wherein the centralized processor based-device is further operable to:
identify one or more public or private railroad crossings that each locomotive of the plurality of operating trains will approach;
based on the received locomotive location data, determine a distance between each locomotive and each of the one or more of identified public or private railroad crossings;
based on the determined distances and the locomotive velocity data, predictively estimate a time of arrival of the locomotive at each of the one or more of identified public or private railroad crossings; and
communicate the predictively estimated a time of arrival of the locomotive to remotely located devices respectively providing notifications to vehicles and persons approaching the respective identified public or private railroad crossing.

38. The system of claim 37, wherein the centralized processor based-device is further operable to:
predictively estimate a blocked crossing duration time for each of the one or more identified public or private railroad crossings; and
communicate the predictively estimated blocked crossing time to remotely located devices respectively providing notifications to vehicles and persons approaching the one or more identified public or private railroad crossing.

39. The system of claim 1, wherein the locomotive location data and velocity data for the plurality of operating trains is generated by trackside reader devices.

40. The system of claim 1, wherein the trackside reader devices are RFID devices.
